(19) United States
(12) Patent Application Publication
(10) Pub. No.: US 2024/0430843 A1
(43) Pub. Date: Dec. 26, 2024

(54) ENHANCED POSITIONING REFERENCE SIGNAL PROCESSING

(71) Applicant: QUALCOMM INCORPORATED, San Diego, CA (US)

(72) Inventors: Weimin DUAN, San Diego, CA (US); June NAMGOONG, San Diego, CA (US); Alexandros MANOLAKOS, Athens (GR); Sooryanarayanan GOPALAKRISHNAN, San Diego, CA (US); Krishna Kiran MUKKAVILLI, San Diego, CA (US); Jay Kumar SUNDARARAJAN, San Diego, CA (US); Tingfang JI, San Diego, CA (US); Renqiu WANG, San Diego, CA (US); Naga BHUSHAN, San Diego, CA (US); Arnold Jason GUM, San Diego, CA (US)

(21) Appl. No.: 18/701,861

(22) PCT Filed: Nov. 22, 2022
(86) PCT No.: PCT/US2022/080323

§ 371 Date: Apr. 16, 2024

(30) Foreign Application Priority Data
Dec. 20, 2021 (GR) 20210100899

(51) Int. Cl. H04W 64/00; H04L 5/00

(52) U.S. Cl. CPC H04W 64/00; H04L 5/0007

(57) ABSTRACT

A positioning reference signal measurement method includes: receiving, at a user equipment from a network entity, an OFDM PRS (orthogonal frequency division multiplexing positioning reference signal) comprising a first set of first OFDM symbols that are consecutive and include a first center symbol and at least one pair of first side symbols disposed symmetrically about the first center symbol and having identical resource element sounding patterns; combining the first side symbols in each of the at least one pair of first side symbols to produce at least one first combined symbol; and determining a measurement of the OFDM PRS based on the at least one first combined symbol and the first center symbol.

### CROSS-REFERENCE TO RELATED APPLICATIONS

This application claims the benefit of Greek patent application Ser. No. 20/210,100899, filed Dec. 20, 2021, entitled “ENHANCED POSITIONING REFERENCE SIGNAL PROCESSING,” which is assigned to the assignee hereof, and the entire contents of which are hereby incorporated herein by reference for all purposes.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long-Term Evolution (LTE) or WiMax), a fifth-generation (5G) service, etc. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Orthogonal Frequency Division Multiple Access (OFDMA), Time Division Multiple Access (TDMA), the Global System for Mobile access (GSM) variation of TDMA, etc.

A fifth generation (5G) mobile standard calls for higher data transfer speeds, greater numbers of connections, and better coverage, among other improvements. The 5G standard, according to the Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments. Consequently, the spectral efficiency of 5G mobile communications should be significantly enhanced compared to the current 4G standard. Furthermore, signaling efficiencies should be enhanced and latency should be substantially reduced compared to current standards.

### SUMMARY

An example user equipment includes: a transceiver; a memory; and a processor, communicatively coupled to the memory and the transceiver, configured to: receive, via the transceiver from a network entity, an OFDM PRS (orthogonal frequency division multiplexing positioning reference signal) including a first set of first OFDM symbols that are consecutive and include a first center symbol and at least one pair of first side symbols disposed symmetrically about the first center symbol and having identical resource element sounding patterns; combine the first side symbols in each of the at least one pair of first side symbols to produce at least one first combined symbol; and determine a measurement of the OFDM PRS based on the at least one first combined symbol and the first center symbol.

An example positioning reference signal measurement method includes: receiving, at a user equipment from a network entity, an OFDM PRS (orthogonal frequency division multiplexing positioning reference signal) including a first set of first OFDM symbols that are consecutive and include a first center symbol and at least one pair of first side symbols disposed symmetrically about the first center symbol and having identical resource element sounding patterns; combining the first side symbols in each of the at least one pair of first side symbols to produce at least one first combined symbol; and determining a measurement of the OFDM PRS based on the at least one first combined symbol and the first center symbol.

Another example user equipment includes: means for receiving, from a network entity, an OFDM PRS (orthogonal frequency division multiplexing positioning reference signal) including a first set of first OFDM symbols that are consecutive and include a first center symbol and at least one pair of first side symbols disposed symmetrically about the first center symbol and having identical resource element sounding patterns; means for combining the first side symbols in each of the at least one pair of first side symbols to produce at least one first combined symbol; and means for determining a measurement of the OFDM PRS based on the at least one first combined symbol and the first center symbol.

An example non-transitory, processor-readable storage medium includes processor-readable instructions to cause a processor of a user equipment to: receive, from a network entity, an OFDM PRS (orthogonal frequency division multiplexing positioning reference signal) including a first set of first OFDM symbols that are consecutive and include a first center symbol and at least one pair of first side symbols disposed symmetrically about the first center symbol and having identical resource element sounding patterns; combine the first side symbols in each of the at least one pair of first side symbols to produce at least one first combined symbol; and determine a measurement of the OFDM PRS based on the at least one first combined symbol and the first center symbol.

An example network entity includes: a transceiver; a memory; and a processor communicatively coupled to the memory and the transceiver; where the processor is configured to: schedule transmission of a first PRS (Positioning Reference Signal), of comb-2 with at least one repetition, in response to an inability indication that indicates an inability of a first user equipment to determine position information with at least a threshold accuracy based on measurement of comb-4, or higher-comb, PRS or based on any comb-2 PRS without a repetition; or schedule transmission of a second PRS that has sounded tones that are symmetrical about a middle symbol of the second PRS; or a combination thereof.

An example positioning reference signal scheduling method includes: scheduling, at a network entity, transmission of a first PRS (Positioning Reference Signal), of comb-2 with at least one repetition, in response to an inability indication that indicates an inability of a first user equipment to determine position information with at least a threshold accuracy based on measurement of comb-4, or higher-comb, PRS or based on any comb-2 PRS without a repetition; or scheduling, at the network entity, transmission of a second PRS that has sounded tones that are symmetrical about a middle symbol of the second PRS; or a combination thereof.

Another example network entity includes: a transceiver; and means for scheduling, via the transceiver, transmission of a first PRS (Positioning Reference Signal), of comb-2 with at least one repetition, in response to an inability indication that indicates an inability of a first user equipment to determine position information with at least a threshold accuracy based on measurement of comb-4, or higher-comb, PRS or based on any comb-2 PRS without a repetition; or means for scheduling, via the transceiver, transmission of a second PRS that has sounded tones that are symmetrical about a middle symbol of the second PRS; or a combination thereof.

Another example non-transitory, processor-readable storage medium includes processor-readable instructions to cause a processor of a network entity to: schedule transmission of a first PRS (Positioning Reference Signal), of comb-2 with at least one repetition, in response to an inability indication that indicates an inability of a first user equipment to determine position information with at least a threshold accuracy based on measurement of comb-4, or higher-comb, PRS or based on any comb-2 PRS without a repetition; or schedule transmission of a second PRS that has sounded tones that are symmetrical about a middle symbol of the second PRS; or a combination thereof.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point.

FIG. 4 is a block diagram of components of an example server, various embodiments of which are shown in FIG. 1.

FIG. 5A is an example of downlink positioning reference signal resource sets with four resources, a repetition factor of four, and a time gap of one slot.

FIG. 5B is another example of downlink positioning reference signal resource sets with four resources, a repetition factor of four, and a time gap of four slots.

FIG. 6A is a simplified comb-2, 2-symbol OFDM (Orthogonal Frequency Division Multiplexing) transmission schedule.

FIG. 6B is a comb-4, 4-symbol OFDM transmission schedule.

FIG. 6C is a comb-2, 12-symbol OFDM transmission schedule.

FIG. 6D is a comb-4, 12-symbol OFDM transmission schedule.

FIG. 6E is a comb-6, 6-symbol OFDM transmission schedule.

FIG. 6F is a comb-12, 12-symbol OFDM transmission schedule.

FIG. 6G is a comb-2, 6-symbol OFDM transmission schedule.

FIG. 6H is a comb-6, 12-symbol OFDM transmission schedule.

FIG. 7 is a block diagram of an example user equipment.

FIG. 8 is a block diagram of an example network entity.

FIG. 9 is a diagram of two OFDM symbols with a relative residual frequency offset between the two OFDM symbols.

FIG. 10 is a simplified diagram of a channel energy response with an actual peak and an aliased peak.

FIG. 11 is a symmetric OFDM transmission schedule of a comb-2 signal spanning three symbols.

FIG. 12 is a symmetric OFDM transmission schedule of a comb-4 signal spanning seven symbols.

FIG. 13 is a symmetric OFDM transmission schedule of a comb-6 signal spanning 11 symbols.

FIG. 14 is an example of an explicit request for a symmetric OFDM transmission schedule.

FIG. 15 is an example of an implicit request for an enhanced positioning reference signal.

FIG. 16 is an example of a look-up table for symmetric transmission schedules.

FIG. 17 is a comb-2 positioning reference signal transmission pattern with a single repetition.

FIG. 18 is an example of an explicit request for a comb-2 transmission schedule with at least one repetition.

FIG. 19 is an example look-up table for comb-2 transmission schedules with at least one repetition.

FIG. 20 is a timing diagram of a signaling and process flow for scheduling and using an enhanced positioning reference signal to determine position information.

FIG. 21 is a block flow diagram of a positioning reference signal measurement method.

FIG. 22 is a block flow diagram of a positioning reference signal scheduling method.

### DETAILED DESCRIPTION

Techniques are discussed herein for enhanced positioning reference signal processing, e.g., scheduling and/or using (e.g., measuring) enhanced positioning reference signals, and/or enhanced measuring of positioning reference signals, e.g., to reduce effects of residual frequency offset. For example, a symmetrical positioning reference signal transmission schedule (also called a transmission pattern) may be explicitly and/or implicitly requested by a user equipment and supplied by a base station (e.g., in conjunction with a server). As another example, a comb-2 positioning reference signal with at least one repetition may be explicitly and/or implicitly requested by a user equipment and supplied by a base station (e.g., in conjunction with a server). The user equipment may process the positioning reference signal by combining symbols with identical resource element sounding and that are disposed symmetrically about a center symbol. The center symbol and the combined symbols may be further combined and processed to determine a measurement of the positioning reference signal, and possibly to determine further position information (e.g., a pseudorange or a position estimate). These implementations are examples, and other implementations may be used.

Items and/or techniques described herein may provide one or more of the following capabilities, as well as other capabilities not mentioned. Effects of residual frequency offset in position information based on positioning reference signal measurements may be reduced. Positioning accuracy may be increased. Other capabilities may be provided and not every implementation according to the disclosure must provide any, let alone all, of the capabilities discussed.

Obtaining the locations of mobile devices that are accessing a wireless network may be useful for many applications including, for example, emergency calls, personal navigation, consumer asset tracking, locating a friend or family member, etc. Existing positioning methods include methods based on measuring radio signals transmitted from a variety of devices or entities including satellite vehicles (SVs) and terrestrial radio sources in a wireless network such as base stations and access points. It is expected that standardization for the 5G wireless networks will include support for various positioning methods, which may utilize reference signals transmitted by base stations in a manner similar to which LTE wireless networks currently utilize Positioning Reference Signals (PRS) and/or Cell-specific Reference Signals (CRS) for position determination.

The description may refer to sequences of actions to be performed, for example, by elements of a computing device. Various actions described herein can be performed by specific circuits (e.g., an application specific integrated circuit (ASIC)), by program instructions being executed by one or more processors, or by a combination of both. Sequences of actions described herein may be embodied within a non-transitory computer-readable medium having stored thereon a corresponding set of computer instructions that upon execution would cause an associated processor to perform the functionality described herein. Thus, the various aspects described herein may be embodied in a number of different forms, all of which are within the scope of the disclosure, including claimed subject matter.

As used herein, the terms “user equipment” (UE) and “base station” are not specific to or otherwise limited to any particular Radio Access Technology (RAT), unless otherwise noted. In general, such UEs may be any wireless communication device (e.g., a mobile phone, router, tablet computer, laptop computer, consumer asset tracking device, Internet of Things (IoT) device, etc.) used by a user to communicate over a wireless communications network. A UE may be mobile or may (e.g., at certain times) be stationary, and may communicate with a Radio Access Network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or UT, a “mobile terminal,” a “mobile station,” a “mobile device,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, WiFi networks (e.g., based on IEEE 802.11, etc.) and so on.

A base station may operate according to one of several RATs in communication with UEs depending on the network in which it is deployed. Examples of a base station include an Access Point (AP), a Network Node, a NodeB, an evolved NodeB (eNB), or a general Node B (gNodeB, gNB). In addition, in some systems a base station may provide purely edge node signaling functions while in other systems it may provide additional control and/or network management functions.

UEs may be embodied by any of a number of types of devices including but not limited to printed circuit (PC) cards, compact flash devices, external or internal modems, wireless or wireline phones, smartphones, tablets, consumer asset tracking devices, asset tags, and so on. A communication link through which UEs can send signals to a RAN is called an uplink channel (e.g., a reverse traffic channel, a reverse control channel, an access channel, etc.). A communication link through which the RAN can send signals to UEs is called a downlink or forward link channel (e.g., a paging channel, a control channel, a broadcast channel, a forward traffic channel, etc.). As used herein the term traffic channel (TCH) can refer to either an uplink/reverse or downlink/forward traffic channel.

As used herein, the term “cell” or “sector” may correspond to one of a plurality of cells of a base station, or to the base station itself, depending on the context. The term “cell” may refer to a logical communication entity used for communication with a base station (for example, over a carrier), and may be associated with an identifier for distinguishing neighboring cells (for example, a physical cell identifier (PCID), a virtual cell identifier (VCID)) operating via the same or a different carrier. In some examples, a carrier may support multiple cells, and different cells may be configured according to different protocol types (for example, machine-type communication (MTC), narrowband Internet-of-Things (NB-IoT), enhanced mobile broadband (eMBB), or others) that may provide access for different types of devices. In some examples, the term “cell” may refer to a portion of a geographic coverage area (for example, a sector) over which the logical entity operates.

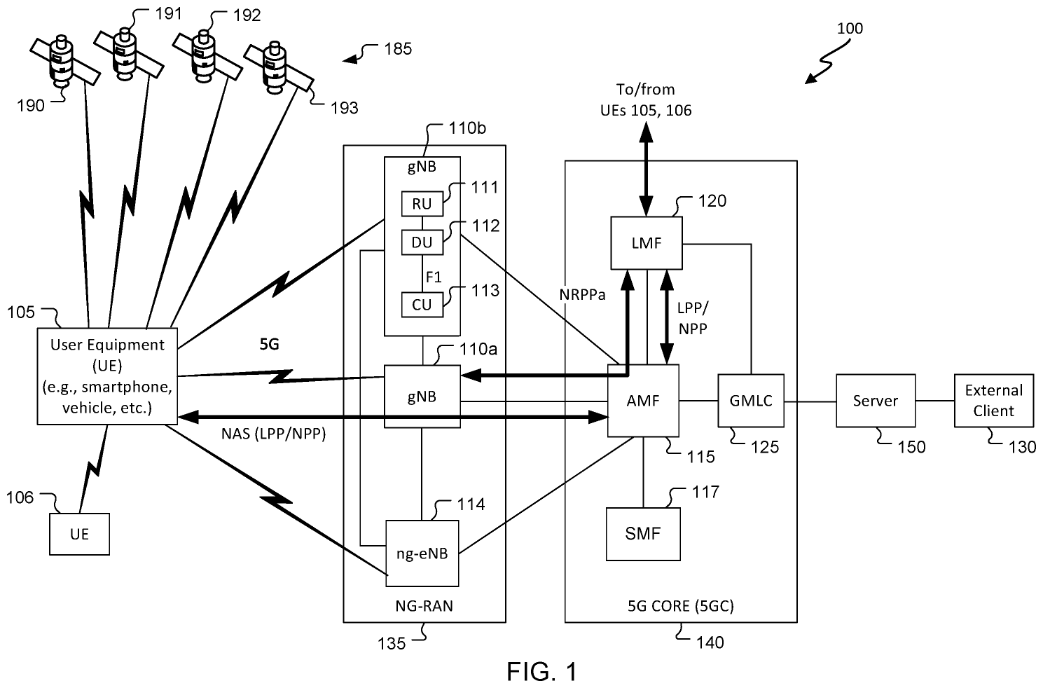

Referring to FIG. 1, an example of a communication system 100 includes a UE 105, a UE 106, a Radio Access Network (RAN), here a Fifth Generation (5G) Next Generation (NG) RAN (NG-RAN) 135, a 5G Core Network (5GC) 140, and a server 150. The UE 105 and/or the UE 106 may be, e.g., an IoT device, a location tracker device, a cellular telephone, a vehicle (e.g., a car, a truck, a bus, a boat, etc.), or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3rd Generation Partnership Project (3GPP). Accordingly, the NG-RAN 135 and the 5GC 140 may conform to current or future standards for 5G support from 3GPP. The NG-RAN 135 may be another type of RAN, e.g., a 3G RAN, a 4G Long-Term Evolution (LTE) RAN, etc. The UE 106 may be configured and coupled similarly to the UE 105 to send and/or receive signals to/from similar other entities in the system 100, but such signaling is not indicated in FIG. 1 for the sake of simplicity of the figure. Similarly, the discussion focuses on the UE 105 for the sake of simplicity. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The gNBs 110a, 110b, and the ng-eNB 114 may be referred to as base stations (BSs). The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions. Base stations such as the gNBs 110a, 110b and/or the ng-eNB 114 may be a macro cell (e.g., a high-power cellular base station), or a small cell (e.g., a low-power cellular base station), or an access point (e.g., a short-range base station configured to communicate with short-range technology such as WiFi, WiFi-Direct (WiFi-D), Bluetooth®, Bluetooth R-low energy (BLE), Zigbee, etc. One or more BSs, e.g., one or more of the gNBs 110a, 110b and/or the ng-eNB 114 may be configured to communicate with the UE 105 via multiple carriers. Each of the gNBs 110a, 110b and the ng-eNB 114 may provide communication coverage for a respective geographic region, e.g. a cell. Each cell may be partitioned into multiple sectors as a function of the base station antennas.

FIG. 1 provides a generalized illustration of various components, any or all of which may be utilized as appropriate, and each of which may be duplicated or omitted as necessary. Specifically, although one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 110b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long-Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The system 100 is capable of wireless communication in that components of the system 100 can communicate with one another (at least some times using wireless connections) directly or indirectly, e.g., via the gNBs 110a, 110b, the ng-eNB 114, and/or the 5GC 140 (and/or one or more other devices not shown, such as one or more other base transceiver stations). For indirect communications, the communications may be altered during transmission from one entity to another, e.g., to alter header information of data packets, to change format, etc. The UE 105 may include multiple UEs and may be a mobile wireless communication device, but may communicate wirelessly and via wired connections. The UE 105 may be any of a variety of devices, e.g., a smartphone, a tablet computer, a vehicle-based device, etc., but these are examples as the UE 105 is not required to be any of these configurations, and other configurations of UEs may be used. Other UEs may include wearable devices (e.g., smart watches, smart jewelry, smart glasses or headsets, etc.). Still other UEs may be used, whether currently existing or developed in the future. Further, other wireless devices (whether mobile or not) may be implemented within the system 100 and may communicate with each other and/or with the UE 105, the gNBs 110a, 110b, the ng-eNB 114, the 5GC 140, and/or the external client 130. For example, such other devices may include internet of thing (IoT) devices, medical devices, home entertainment and/or automation devices, etc. The 5GC 140 may communicate with the external client 130 (e.g., a computer system), e.g., to allow the external client 130 to request and/or receive location information regarding the UE 105 (e.g., via the GMLC 125).

The UE 105 or other devices may be configured to communicate in various networks and/or for various purposes and/or using various technologies (e.g., 5G, Wi-Fi communication, multiple frequencies of Wi-Fi communication, satellite positioning, one or more types of communications (e.g., GSM (Global System for Mobiles), CDMA (Code Division Multiple Access), LTE (Long-Term Evolution), V2X (Vehicle-to-Everything, e.g., V2P (Vehicle-to-Pedestrian), V2I (Vehicle-to-Infrastructure), V2V (Vehicle-to-Vehicle), etc.), IEEE 802.11p, etc.). V2X communications may be cellular (Cellular-V2X (C-V2X)) and/or WiFi (e.g., DSRC (Dedicated Short-Range Connection)). The system 100 may support operation on multiple carriers (waveform signals of different frequencies). Multi-carrier transmitters can transmit modulated signals simultaneously on the multiple carriers. Each modulated signal may be a Code Division Multiple Access (CDMA) signal, a Time Division Multiple Access (TDMA) signal, an Orthogonal Frequency Division Multiple Access (OFDMA) signal, a Single-Carrier Frequency Division Multiple Access (SC-FDMA) signal, etc. Each modulated signal may be sent on a different carrier and may carry pilot, overhead information, data, etc. The UEs 105, 106 may communicate with each other through UE-to-UE sidelink (SL) communications by transmitting over one or more sidelink channels such as a physical sidelink synchronization channel (PSSCH), a physical sidelink broadcast channel (PSBCH), or a physical sidelink control channel (PSCCH).

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, consumer asset tracking device, navigation device, Internet of Things (IoT) device, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas, or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP. One or more of a group of UEs utilizing D2D communications may be within a geographic coverage area of a TRP. Other UEs in such a group may be outside such geographic coverage areas, or be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a. 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The gNBs 110a, 110b and/or the ng-eNB 114 may each comprise one or more TRPs. For example, each sector within a cell of a BS may comprise a TRP, although multiple TRPs may share one or more components (e.g., share a processor but have separate antennas). The system 100 may include macro TRPs exclusively or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

Each of the gNBs 110a, 110b and/or the ng-eNB 114 may include a radio unit (RU), a distributed unit (DU), and a central unit (CU). For example, the gNB 110a includes an RU 111, a DU 112, and a CU 113. The RU 111, DU 112, and CU 113 divide functionality of the gNB 110a. While the gNB 110a is shown with a single RU, a single DU, and a single CU, a gNB may include one or more RUs, one or more DUs, and/or one or more CUs. An interface between the CU 113 and the DU 112 is referred to as an F1 interface. The RU 111 is configured to perform digital front end (DFE) functions (e.g., analog-to-digital conversion, filtering, power amplification, transmission/reception) and digital beamforming, and includes a portion of the physical (PHY) layer. The RU 111 may perform the DFE using massive multiple input/multiple output (MIMO) and may be integrated with one or more antennas of the gNB 110a. The DU 112 hosts the Radio Link Control (RLC), Medium Access Control (MAC), and physical layers of the gNB 110a. One DU can support one or more cells, and each cell is supported by a single DU. The operation of the DU 112 is controlled by the CU 113. The CU 113 is configured to perform functions for transferring user data, mobility control, radio access network sharing, positioning, session management, etc. although some functions are allocated exclusively to the DU 112. The CU 113 hosts the Radio Resource Control (RRC), Service Data Adaptation Protocol (SDAP), and Packet Data Convergence Protocol (PDCP) protocols of the gNB 110a. The UE 105 may communicate with the CU 113 via RRC, SDAP, and PDCP layers, with the DU 112 via the RLC, MAC, and PHY layers, and with the RU 111 via the PHY layer.

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications, or directly with the gNBs 110a, 110b and/or the ng-eNB 114. The LMF 120 may support positioning of the UE 105 when the UE 105 accesses the NG-RAN 135 and may support position procedures/methods such as Assisted GNSS (A-GNSS), Observed Time Difference of Arrival (OTDOA) (e.g., Downlink (DL) OTDOA or Uplink (UL) OTDOA), Round Trip Time (RTT), Multi-Cell RTT, Real Time Kinematic (RTK), Precise Point Positioning (PPP), Differential GNSS (DGNSS), Enhanced Cell ID (E-CID), angle of arrival (AoA), angle of departure (AoD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP).

At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120). The AMF 115 may serve as a control node that processes signaling between the UE 105 and the 5GC 140, and may provide QOS (Quality of Service) flow and session management. The AMF 115 may support mobility of the UE 105 including cell change and handover and may participate in supporting signaling connection to the UE 105.

The server 150, e.g., a cloud server, is configured to obtain and provide location estimates of the UE 105 to the external client 130. The server 150 may, for example, be configured to run a microservice/service that obtains the location estimate of the UE 105. The server 150 may, for example, pull the location estimate from (e.g., by sending a location request to) the UE 105, one or more of the gNBs 110a, 110b (e.g., via the RU 111, the DU 112, and the CU 113) and/or the ng-eNB 114, and/or the LMF 120. As another example, the UE 105, one or more of the gNBs 110a, 110b (e.g., via the RU 111, the DU 112, and the CU 113), and/or the LMF 120 may push the location estimate of the UE 105 to the server 150.

The GMLC 125 may support a location request for the UE 105 received from the external client 130 via the server 150 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130 via the server 150. The GMLC 125 is shown connected to both the AMF 115 and LMF 120, though may not be connected to the AMF 115 or the LMF 120 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a. 110b or the ng-eNB 114) and/or may be used by the LMF 120 to obtain location related information from the gNBs 110a, 110b and/or the ng-eNB 114, such as parameters defining directional SS or PRS transmissions from the gNBs 110a, 110b, and/or the ng-eNB 114. The LMF 120 may be co-located or integrated with a gNB or a TRP, or may be disposed remote from the gNB and/or the TRP and configured to communicate directly or indirectly with the gNB and/or the TRP.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time of Arrival (ToA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS or PRS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 140. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS or PRS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS or PRS beams from a plurality of base stations (such as the gNBs 110a, 110b, the ng-eNB 114, etc.) to compute the UE's position.

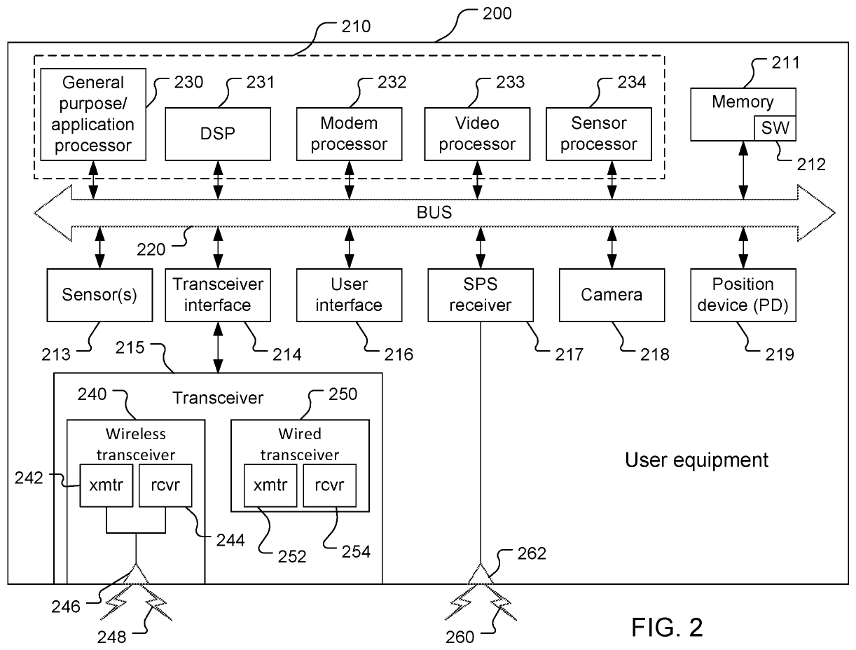

Referring also to FIG. 2, a UE 200 is an example of one of the UEs 105, 106 and comprises a computing platform including a processor 210, memory 211 including software (SW) 212, one or more sensors 213, a transceiver interface 214 for a transceiver 215 (that includes a wireless transceiver 240 and a wired transceiver 250), a user interface 216, a Satellite Positioning System (SPS) receiver 217, a camera 218, and a position device (PD) 219. The processor 210, the memory 211, the sensor(s) 213, the transceiver interface 214, the user interface 216, the SPS receiver 217, the camera 218, and the position device 219 may be communicatively coupled to each other by a bus 220 (which may be configured, e.g., for optical and/or electrical communication). One or more of the shown apparatus (e.g., the camera 218, the position device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for RF (radio frequency) sensing (with one or more (cellular) wireless signals transmitted and reflection(s) used to identify, map, and/or track an object), and/or ultrasound, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, a wireless transceiver, and one or more of the sensor(s) 213, the user interface 216, the SPS receiver 217, the camera 218, the PD 219, and/or a wired transceiver.

The UE 200 may comprise the modem processor 232 that may be capable of performing baseband processing of signals received and down-converted by the transceiver 215 and/or the SPS receiver 217. The modem processor 232 may perform baseband processing of signals to be upconverted for transmission by the transceiver 215. Also or alternatively, baseband processing may be performed by the general-purpose/application processor 230 and/or the DSP 231. Other configurations, however, may be used to perform baseband processing.

The UE 200 may include the sensor(s) 213 that may include, for example, one or more of various types of sensors such as one or more inertial sensors, one or more magnetometers, one or more environment sensors, one or more optical sensors, one or more weight sensors, and/or one or more radio frequency (RF) sensors, etc. An inertial measurement unit (IMU) may comprise, for example, one or more accelerometers (e.g., collectively responding to acceleration of the UE 200 in three dimensions) and/or one or more gyroscopes (e.g., three-dimensional gyroscope(s)). The sensor(s) 213 may include one or more magnetometers (e.g., three-dimensional magnetometer(s)) to determine orientation (e.g., relative to magnetic north and/or true north) that may be used for any of a variety of purposes, e.g., to support one or more compass applications. The environment sensor(s) may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the general-purpose/application processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU may be configured to provide measurements about a direction of motion and/or a speed of motion of the UE 200, which may be used in relative location determination. For example, one or more accelerometers and/or one or more gyroscopes of the IMU may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) and gyroscope(s) taken after this moment in time may be used in dead reckoning to determine present location of the UE 200 based on movement (direction and distance) of the UE 200 relative to the reference location.

The magnetometer(s) may determine magnetic field strengths in different directions which may be used to determine orientation of the UE 200. For example, the orientation may be used to provide a digital compass for the UE 200. The magnetometer(s) may include a two-dimensional magnetometer configured to detect and provide indications of magnetic field strength in two orthogonal dimensions. The magnetometer(s) may include a three-dimensional magnetometer configured to detect and provide indications of magnetic field strength in three orthogonal dimensions. The magnetometer(s) may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a wireless transmitter 242 and a wireless receiver 244 coupled to an antenna 246 for transmitting (e.g., on one or more uplink channels and/or one or more sidelink channels) and/or receiving (e.g., on one or more downlink channels and/or one or more sidelink channels) wireless signals 248 and transducing signals from the wireless signals 248 to wired (e.g., electrical and/or optical) signals and from wired (e.g., electrical and/or optical) signals to the wireless signals 248. The wireless transmitter 242 includes appropriate components (e.g., a power amplifier and a digital-to-analog converter). The wireless receiver 244 includes appropriate components (e.g., one or more amplifiers, one or more frequency filters, and an analog-to-digital converter). The wireless transmitter 242 may include multiple transmitters that may be discrete components or combined/integrated components, and/or the wireless receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802. 11 (including IEEE 802.11p), WiFi, WiFi Direct (WiFi-D), Bluetooth®, Zigbee etc. New Radio may use mm-wave frequencies and/or sub-6 GHZ frequencies. The wired transceiver 250 may include a wired transmitter 252 and a wired receiver 254 configured for wired communication, e.g., a network interface that may be utilized to communicate with the NG-RAN 135 to send communications to, and receive communications from, the NG-RAN 135. The wired transmitter 252 may include multiple transmitters that may be discrete components or combined/integrated components, and/or the wired receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215. The wireless transmitter 242, the wireless receiver 244, and/or the antenna 246 may include multiple transmitters, multiple receivers, and/or multiple antennas, respectively, for sending and/or receiving, respectively, appropriate signals.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose/application processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The SPS antenna 262 is configured to transduce the SPS signals 260 from wireless signals to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose/application processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose/application processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose/application processor 230 and/or the DSP 231. Also or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position device (PD) 219 may be configured to determine a position of the UE 200, motion of the UE 200, and/or relative position of the UE 200, and/or time. For example, the PD 219 may communicate with, and/or include some or all of, the SPS receiver 217. The PD 219 may work in conjunction with the processor 210 and the memory 211 as appropriate to perform at least a portion of one or more positioning methods, although the description herein may refer to the PD 219 being configured to perform, or performing, in accordance with the positioning method(s). The PD 219 may also or alternatively be configured to determine location of the UE 200 using terrestrial-based signals (e.g., at least some of the signals 248) for trilateration, for assistance with obtaining and using the SPS signals 260, or both. The PD 219 may be configured to determine location of the UE 200 based on a cell of a serving base station (e.g., a cell center) and/or another technique such as E-CID. The PD 219 may be configured to use one or more images from the camera 218 and image recognition combined with known locations of landmarks (e.g., natural landmarks such as mountains and/or artificial landmarks such as buildings, bridges, streets, etc.) to determine location of the UE 200. The PD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the general-purpose/application processor 230 and/or the DSP 231) may be configured to use to determine motion (e.g., a velocity vector and/or an acceleration vector) of the UE 200. The PD 219 may be configured to provide indications of uncertainty and/or error in the determined position and/or motion. Functionality of the PD 219 may be provided in a variety of manners and/or configurations, e.g., by the general-purpose/application processor 230, the transceiver 215, the SPS receiver 217, and/or another component of the UE 200, and may be provided by hardware, software, firmware, or various combinations thereof.

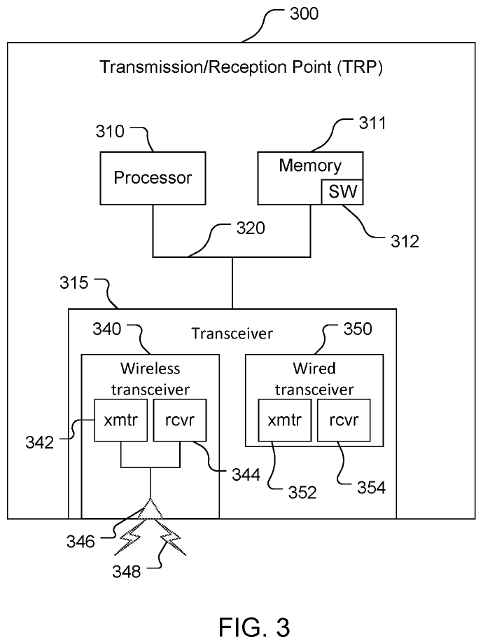

Referring also to FIG. 3, an example of a TRP 300 of the gNBs 110a, 110b and/or the ng-eNB 114 comprises a computing platform including a processor 310, memory 311 including software (SW) 312, and a transceiver 315. The processor 310, the memory 311, and the transceiver 315 may be communicatively coupled to each other by a bus 320 (which may be configured, e.g., for optical and/or electrical communication). One or more of the shown apparatus (e.g., a wireless transceiver) may be omitted from the TRP 300. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions.

The description may refer to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components (e.g., the processor 310 and the memory 311) of the TRP 300 (and thus of one of the gNBs 110a, 110b and/or the ng-eNB 114) performing the function. The processor 310 may include a memory with stored instructions in addition to and/or instead of the memory 311. Functionality of the processor 310 is discussed more fully below.

The transceiver 315 may include a wireless transceiver 340 and/or a wired transceiver 350 configured to communicate with other devices through wireless connections and wired connections, respectively. For example, the wireless transceiver 340 may include a wireless transmitter 342 and a wireless receiver 344 coupled to one or more antennas 346 for transmitting (e.g., on one or more uplink channels and/or one or more downlink channels) and/or receiving (e.g., on one or more downlink channels and/or one or more uplink channels) wireless signals 348 and transducing signals from the wireless signals 348 to wired (e.g., electrical and/or optical) signals and from wired (e.g., electrical and/or optical) signals to the wireless signals 348. Thus, the wireless transmitter 342 may include multiple transmitters that may be discrete components or combined/integrated components, and/or the wireless receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802. 11 (including IEEE 802.11p), WiFi, WiFi Direct (WiFi-D), Bluetooth®, Zigbee etc. The wired transceiver 350 may include a wired transmitter 352 and a wired receiver 354 configured for wired communication, e.g., a network interface that may be utilized to communicate with the NG-RAN 135 to send communications to, and receive communications from, the LMF 120, for example, and/or one or more other network entities. The wired transmitter 352 may include multiple transmitters that may be discrete components or combined/integrated components, and/or the wired receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

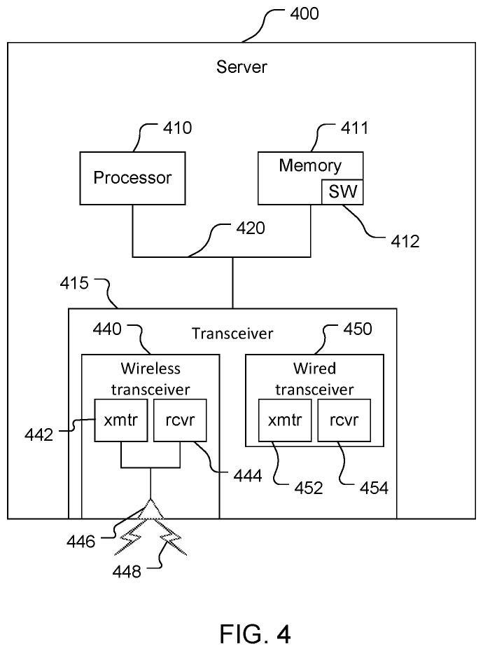

Referring also to FIG. 4, a server 400, of which the LMF 120 is an example, comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless transceiver) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 performing a function as shorthand for one or more appropriate components of the server 400 performing the function. The processor 410 may include a memory with stored instructions in addition to and/or instead of the memory 411. Functionality of the processor 410 is discussed more fully below:

The transceiver 415 may include a wireless transceiver 440 and/or a wired transceiver 450 configured to communicate with other devices through wireless connections and wired connections, respectively. For example, the wireless transceiver 440 may include a wireless transmitter 442 and a wireless receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the wireless transmitter 442 may include multiple transmitters that may be discrete components or combined/integrated components, and/or the wireless receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a wired transmitter 452 and a wired receiver 454 configured for wired communication, e.g., a network interface that may be utilized to communicate with the NG-RAN 135 to send communications to, and receive communications from, the TRP 300, for example, and/or one or more other network entities. The wired transmitter 452 may include multiple transmitters that may be discrete components or combined/integrated components, and/or the wired receiver 454 may include multiple receivers that may be discrete components or combined/integrated components. The wired transceiver 450 may be configured, e.g., for optical communication and/or electrical communication.

The description herein may refer to the processor 410 performing a function, but this includes other implementations such as where the processor 410 executes software (stored in the memory 411) and/or firmware. The description herein may refer to the server 400 performing a function as shorthand for one or more appropriate components (e.g., the processor 410 and the memory 411) of the server 400 performing the function. The configuration of the server 400 shown in FIG. 4 is an example and not

limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

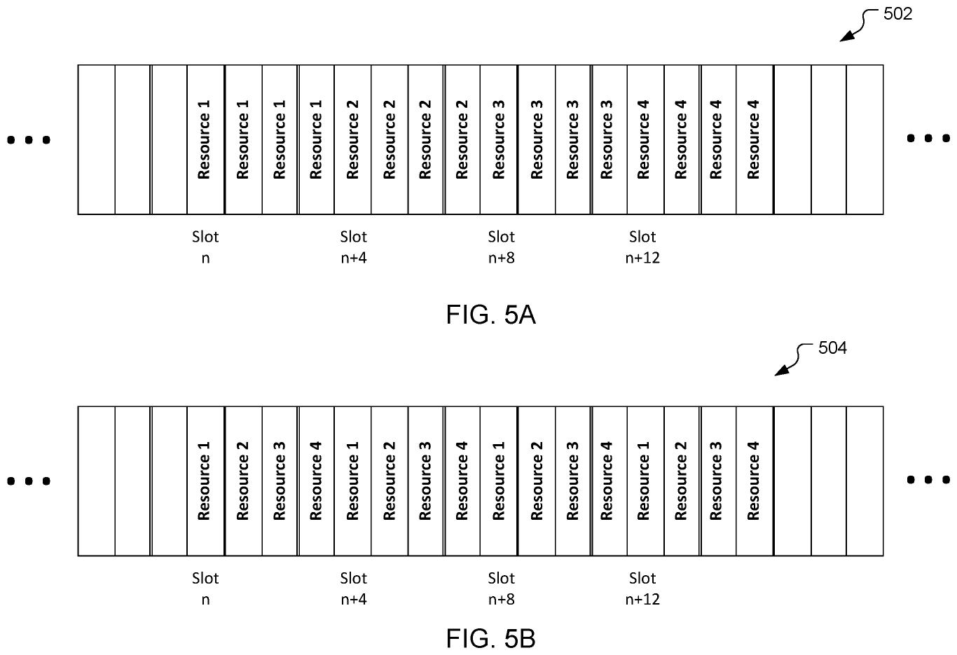

Referring also to FIGS. 5A and 5B, example downlink PRS resource sets are shown. In general, a PRS resource set is a collection of PRS resources across one base station (e.g., the TRP 300) which have the same periodicity, a common muting pattern configuration, and the same repetition factor across slots. A first PRS resource set 502 includes four resources and a repetition factor of four, with a time-gap equal to one slot. A second PRS resource set 504 includes four resources and a repetition factor of four with a time-gap equal to four slots. The repetition factor indicates the number of times each PRS resource is repeated in each single instance of the PRS resource set (e.g., values of 1, 2, 4, 6, 8, 16, 32). The time-gap represents the offset in units of slots between two repeated instances of a PRS resource corresponding to the same PRS resource ID within a single instance of the PRS resource set (e.g., values of 1, 2, 4, 8, 16, 32). The time duration spanned by one PRS resource set containing repeated PRS resources does not exceed PRS-periodicity. The repetition of a PRS resource enables receiver beam sweeping across repetitions and combining RF gains to increase coverage. The repetition may also enable intra-instance muting. A single instance of a PRS Resource Set as shown in FIG. 5A and FIG. 5B may also be referred to as a “PRS occasion”.

In general, the PRS resources depicted in FIGS. 5A and 5B may be a collection of resource elements that are used for transmission of PRS. The collection of resource elements can span multiple physical resource blocks (PRBs) in the frequency domain and N (e.g., 1 or more) consecutive symbol(s) within a slot in the time domain. In a given OFDM symbol, a PRS resource occupies consecutive PRBs. A PRS resource is described by at least the following parameters; PRS resource identifier (ID), sequence ID, comb size-N, resource element offset in the frequency domain, starting slot and starting symbol, number of symbols per PRS resource (i.e., the duration of the PRS resource), and QCL (Quasi Co-Location) information (e.g., QCL with other DL reference signals). The comb size indicates the number of subcarriers in each symbol carrying PRS. For example, a comb-size of comb-4 means that every fourth subcarrier of a given symbol carries PRS.

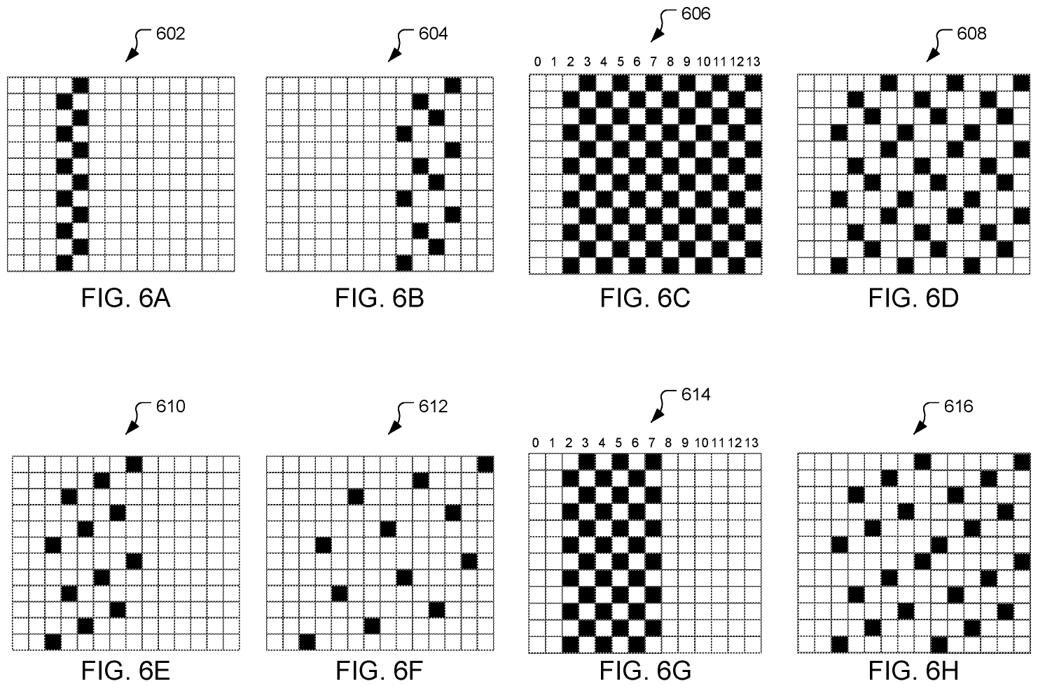

Referring also to FIGS. 6A-6H, example subframe and slot formats for positioning reference signal transmission schedules (also called transmission patterns, including transmission patterns within individual symbols) are shown. The example subframe and slot formats are included in the PRS resource sets depicted in FIGS. 5A and 5B. The subframes and slot formats in FIGS. 6A-6H are examples and not exhaustive and include a comb-2, 2-symbol transmission schedule 602, a comb-4, 4-symbol transmission schedule 604, a comb-2, 12-symbol transmission schedule 606, a comb-4, 12-symbol transmission schedule 608, a comb-6, 6-symbol transmission schedule 610, a comb-12, 12-symbol transmission schedule 612, a comb-2, 6-symbol transmission schedule 614, and a comb-6, 12-symbol transmission schedule 616. In general, a subframe may include 14 symbols with indices 0 to 13. Typically, a base station may transmit the PRS from an antenna port (e.g., antenna port 5000) on one or more slots in each subframe configured for PRS transmission.

A base station may transmit PRS over a particular PRS bandwidth, which may be configured by higher layers. A PRS Resource may be located anywhere in the frequency grid. A common reference point for the PRS may be defined as “PRS Point A”. The “PRS Point A” may serve as a common reference point for the PRS resource block grid and may be represented by an Absolute Radio Frequency Channel Number (ARFCN). The PRS Start Physical Resource Block (PRB) may be defined as a frequency offset between PRS Point A and a lowest subcarrier of a lowest PRS resource block expressed in units of resource blocks. The base station may transmit the PRS on subcarriers spaced apart across the PRS bandwidth.

The base station may also transmit the PRS based on parameters such as PRS periodicity, PRS Resource Set Slot Offset, PRS Resource Slot Offset, PRS Resource Repetition Factor and PRS Resource Time Gap. PRS periodicity is the periodicity at which the PRS Resource is transmitted in number of slots. The PRS periodicity may depend on the subcarrier spacing (SCS) and may be, for example, 2^{μ}{4, 5, 8, 10, 16, 20, 32, 40, 64, 80, 160, 320, 640, 1280, 2560, 5120, 10240} slots, with μ=0, 1, 2, 3 for SCS 15, 30, 60, and 120 kHz, respectively. PRS Resource Set Slot Offset defines the slot offset with respect to System Frame Number (SFN)/Slot Number zero of the TRP (i.e., defines the slot where the first PRS Resource of the PRS Resource Set occurs). PRS Resource Slot Offset defines the starting slot of the PRS Resource with respect to the corresponding PRS Resource Set Slot Offset. PRS Resource Repetition Factor defines how many times each PRS Resource is repeated for a single instance of the PRS Resource Set. PRS Resource Time Gap defines the offset in number of slots between two repeated instances of a PRS Resource within a single instance of the PRS Resource Set, as described above.

A PRS Resource may be muted. Muting may be signaled using a bit-map to indicate which configured PRS Resources are transmitted with zero-power (i.e., muted). In one option, the muting bit map may have a length of {2, 4, 6, 8, 16, 32} bits and muting is applied on each transmission instance of a PRS Resource Set. Each bit in the bit map may correspond to a configurable number of consecutive instances of a PRS Resource Set. All PRS Resources within a PRS Resource Set instance may be muted (transmitted with zero power), e.g., if the corresponding bit in the bit map indicates a ‘0’. The number of consecutive instances may be controlled by the parameter PRS Muting-Bit Repetition Factor, which may have a value of {1, 2, 4, 8}. In another option, muting may be applied on each repetition of each of the PRS Resources. Each bit in the bit map may correspond to a single repetition of the PRS Resource within an instance of a PRS Resource Set. The length of the bit map may be equal to the PRS Resource Repetition Factor.

### Positioning Techniques

For terrestrial positioning of a UE in cellular networks, techniques such as Advanced Forward Link Trilateration (AFLT) and Observed Time Difference Of Arrival (OTDOA) often operate in “UE-assisted” mode in which measurements of reference signals (e.g., PRS, CRS, etc.) transmitted by base stations are taken by the UE and then provided to a location server. The location server then calculates the position of the UE based on the measurements and known locations of the base stations. Because these techniques use the location server to calculate the position of the UE, rather than the UE itself, these positioning techniques are not frequently used in applications such as car or cell-phone navigation, which instead typically rely on satellite-based positioning.

A UE may use a Satellite Positioning System (SPS) (a Global Navigation Satellite System (GNSS)) for high-accuracy positioning using precise point positioning (PPP) or real time kinematic (RTK) technology. These technologies use assistance data such as measurements from ground-based stations. LTE Release 15 allows the data to be encrypted so that the UEs subscribed to the service exclusively can read the information. Such assistance data varies with time. Thus, a UE subscribed to the service may not easily “break encryption” for other UEs by passing on the data to other UEs that have not paid for the subscription. The passing on would need to be repeated every time the assistance data changes.

In UE-assisted positioning, the UE sends measurements (e.g., TDOA, Angle of Arrival (AoA), etc.) to the positioning server (e.g., LMF/eSMLC). The positioning server has the base station almanac (BSA) that contains multiple ‘entries’ or ‘records “, one record per cell, where each record contains geographical cell location but also may include other data. An identifier of the ‘record’ among the multiple ‘records’ in the BSA may be referenced. The BSA and the measurements from the UE may be used to compute the position of the UE.

In conventional UE-based positioning, a UE computes its own position, thus avoiding sending measurements to the network (e.g., location server), which in turn improves latency and scalability. The UE uses relevant BSA record information (e.g., locations of gNBs (more broadly base stations)) from the network. The BSA information may be encrypted. But since the BSA information varies much less often than, for example, the PPP or RTK assistance data described earlier, it may be easier to make the BSA information (compared to the PPP or RTK information) available to UEs that did not subscribe and pay for decryption keys. Transmissions of reference signals by the gNBs make BSA information potentially accessible to crowd-sourcing or war-driving, essentially enabling BSA information to be generated based on in-the-field and/or over-the-top observations.

Positioning techniques may be characterized and/or assessed based on one or more criteria such as position determination accuracy and/or latency. Latency is a time elapsed between an event that triggers determination of position-related data and the availability of that data at a positioning system interface, e.g., an interface of the LMF 120. At initialization of a positioning system, the latency for the availability of position-related data is called time to first fix (TTFF), and is larger than latencies after the TTFF. An inverse of a time elapsed between two consecutive position-related data availabilities is called an update rate, i.e., the rate at which position-related data are generated after the first fix. Latency may depend on processing capability, e.g., of the UE. For example, a UE may report a processing capability of the UE as a duration of DL PRS symbols in units of time (e.g., milliseconds) that the UE can process every T amount of time (e.g., T ms) assuming 272 PRB (Physical Resource Block) allocation. Other examples of capabilities that may affect latency are a number of TRPs from which the UE can process PRS, a number of PRS that the UE can process, and a bandwidth of the UE.

One or more of many different positioning techniques (also called positioning methods) may be used to determine position of an entity such as one of the UEs 105, 106. For example, known position-determination techniques include RTT, multi-RTT, OTDOA (also called TDOA and including UL-TDOA and DL-TDOA), Enhanced Cell Identification (E-CID), DL-AoD, UL-AoA, etc. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a UE) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the UE), estimated timing and power of detected neighbor cell signals, and possibly angle of arrival (e.g., of a signal at the UE from the base station or vice versa) to determine location of the UE. In TDOA, the difference in arrival times at a receiving device of signals from different sources along with known locations of the sources and known offset of transmission times from the sources are used to determine the location of the receiving device.

In a network-centric RTT estimation, the serving base station instructs the UE to scan for/receive RTT measurement signals (e.g., PRS) on serving cells of two or more neighboring base stations (and typically the serving base station, as at least three base stations are needed). The one of more base stations transmit RTT measurement signals on low reuse resources (e.g., resources used by the base station to transmit system information) allocated by the network (e.g., a location server such as the LMF 120). The UE records the arrival time (also referred to as a receive time, a reception time, a time of reception, or a time of arrival (ToA)) of each RTT measurement signal relative to the UE's current downlink timing (e.g., as derived by the UE from a DL signal received from its serving base station), and transmits a common or individual RTT response message (e.g., SRS (sounding reference signal) for positioning, i.e., UL-PRS) to the one or more base stations (e.g., when instructed by its serving base station) and may include the time difference TRx-Tx (i.e., UE TRx-Tx or UERx-Tx) between the ToA of the RTT measurement signal and the transmission time of the RTT response message in a payload of each RTT response message. The RTT response message would include a reference signal from which the base station can deduce the ToA of the RTT response. By comparing the difference TTx-Rx between the transmission time of the RTT measurement signal from the base station and the ToA of the RTT response at the base station to the UE-reported time difference TRx-Tx, the base station can deduce the propagation time between the base station and the UE, from which the base station can determine the distance between the UE and the base station by assuming the speed of light during this propagation time.

A UE-centric RTT estimation is similar to the network-based method, except that the UE transmits uplink RTT measurement signal(s) (e.g., when instructed by a serving base station), which are received by multiple base stations in the neighborhood of the UE. Each involved base station responds with a downlink RTT response message, which may include the time difference between the ToA of the RTT measurement signal at the base station and the transmission time of the RTT response message from the base station in the RTT response message payload.

For both network-centric and UE-centric procedures, the side (network or UE) that performs the RTT calculation typically (though not always) transmits the first message(s) or signal(s) (e.g., RTT measurement signal(s)), while the other side responds with one or more RTT response message(s) or signal(s) that may include the difference between the ToA of the first message(s) or signal(s) and the transmission time of the RTT response message(s) or signal(s).

A multi-RTT technique may be used to determine position. For example, a first entity (e.g., a UE) may send out one or more signals (e.g., unicast, multicast, or broadcast from the base station) and multiple second entities (e.g., other TSPs such as base station(s) and/or UE(s)) may receive a signal from the first entity and respond to this received signal. The first entity receives the responses from the multiple second entities. The first entity (or another entity such as an LMF) may use the responses from the second entities to determine ranges to the second entities and may use the multiple ranges and known locations of the second entities to determine the location of the first entity by trilateration.

In some instances, additional information may be obtained in the form of an angle of arrival (AoA) or angle of departure (AoD) that defines a straight-line direction (e.g., which may be in a horizontal plane or in three dimensions) or possibly a range of directions (e.g., for the UE from the locations of base stations). The intersection of two directions can provide another estimate of the location for the UE.

For positioning techniques using PRS (Positioning Reference Signal) signals (e.g., TDOA and RTT), PRS signals sent by multiple TRPs are measured and the arrival times of the signals, known transmission times, and known locations of the TRPs used to determine ranges from a UE to the TRPs. For example, an RSTD (Reference Signal Time Difference) may be determined for PRS signals received from multiple TRPs and used in a TDOA technique to determine position (location) of the UE. A positioning reference signal may be referred to as a PRS or a PRS signal. The PRS signals are typically sent using the same power and PRS signals with the same signal characteristics (e.g., same frequency shift) may interfere with each other such that a PRS signal from a more distant TRP may be overwhelmed by a PRS signal from a closer TRP such that the signal from the more distant TRP may not be detected. PRS muting may be used to help reduce interference by muting some PRS signals (reducing the power of the PRS signal, e.g., to zero and thus not transmitting the PRS signal). In this way, a weaker (at the UE) PRS signal may be more easily detected by the UE without a stronger PRS signal interfering with the weaker PRS signal. The term RS, and variations thereof (e.g., PRS, SRS, CSI-RS ((Channel State Information-Reference Signal)), may refer to one reference signal or more than one reference signal.

Positioning reference signals (PRS) include downlink PRS (DL PRS, often referred to simply as PRS) and uplink PRS (UL PRS) (which may be called SRS (Sounding Reference Signal) for positioning). A PRS may comprise a PN code (pseudorandom number code) or be generated using a PN code (e.g., by modulating a carrier signal with the PN code) such that a source of the PRS may serve as a pseudo-satellite (a pseudolite). The PN code may be unique to the PRS source (at least within a specified area such that identical PRS from different PRS sources do not overlap). PRS may comprise PRS resources and/or PRS resource sets of a frequency layer. A DL PRS positioning frequency layer (or simply a frequency layer) is a collection of DL PRS resource sets, from one or more TRPs, with PRS resource(s) that have common parameters configured by higher-layer parameters DL-PRS-PositioningFrequencyLayer. DL-PRS-ResourceSet, and DL-PRS-Resource. Each frequency layer has a DL PRS subcarrier spacing (SCS) for the DL PRS resource sets and the DL PRS resources in the frequency layer. Each frequency layer has a DL PRS cyclic prefix (CP) for the DL PRS resource sets and the DL PRS resources in the frequency layer. In 5G, a resource block occupies 12 consecutive subcarriers and a specified number of symbols. Common resource blocks are the set of resource blocks that occupy a channel bandwidth. A bandwidth part (BWP) is a set of contiguous common resource blocks and may include all the common resource blocks within a channel bandwidth or a subset of the common resource blocks. Also, a DL PRS Point A parameter defines a frequency of a reference resource block (and the lowest subcarrier of the resource block), with DL PRS resources belonging to the same DL PRS resource set having the same Point A and all DL PRS resource sets belonging to the same frequency layer having the same Point A. A frequency layer also has the same DL PRS bandwidth, the same start PRB (and center frequency), and the same value of comb size (i.e., a frequency of PRS resource elements per symbol such that for comb-N, every Nth resource element is a PRS resource element). A PRS resource set is identified by a PRS resource set ID and may be associated with a particular TRP (identified by a cell ID) transmitted by an antenna panel of a base station. A PRS resource ID in a PRS resource set may be associated with an omnidirectional signal, and/or with a single beam (and/or beam ID) transmitted from a single base station (where a base station may transmit one or more beams). Each PRS resource of a PRS resource set may be transmitted on a different beam and as such, a PRS resource (or simply resource) can also be referred to as a beam. This does not have any implications on whether the base stations and the beams on which PRS are transmitted are known to the UE.

A TRP may be configured, e.g., by instructions received from a server and/or by software in the TRP, to send DL PRS per a schedule. According to the schedule, the TRP may send the DL PRS intermittently, e.g., periodically at a consistent interval from an initial transmission. The TRP may be configured to send one or more PRS resource sets. A resource set is a collection of PRS resources across one TRP, with the resources having the same periodicity, a common muting pattern configuration (if any), and the same repetition factor across slots. Each of the PRS resource sets comprises multiple PRS resources, with each PRS resource comprising multiple OFDM (Orthogonal Frequency Division Multiplexing) Resource Elements (REs) that may be in multiple Resource Blocks (RBs) within N (one or more) consecutive symbol(s) within a slot. PRS resources (or reference signal (RS) resources generally) may be referred to as OFDM PRS resources (or OFDM RS resources). An RB is a collection of REs spanning a quantity of one or more consecutive symbols in the time domain and a quantity (12 for a 5G RB) of consecutive sub-carriers in the frequency domain. Each PRS resource is configured with an RE offset, slot offset, a symbol offset within a slot, and a number of consecutive symbols that the PRS resource may occupy within a slot. The RE offset defines the starting RE offset of the first symbol within a DL PRS resource in frequency. The relative RE offsets of the remaining symbols within a DL PRS resource are defined based on the initial offset. The slot offset is the starting slot of the DL PRS resource with respect to a corresponding resource set slot offset. The symbol offset determines the starting symbol of the DL PRS resource within the starting slot. Transmitted REs may repeat across slots, with each transmission being called a repetition such that there may be multiple repetitions in a PRS resource. The DL PRS resources in a DL PRS resource set are associated with the same TRP and each DL PRS resource has a DL PRS resource ID. A DL PRS resource ID in a DL PRS resource set is associated with a single beam transmitted from a single TRP (although a TRP may transmit one or more beams).

A PRS resource may also be defined by quasi-co-location and start PRB parameters. A quasi-co-location (QCL) parameter may define any quasi-co-location information of the DL PRS resource with other reference signals. The DL PRS may be configured to be QCL type D with a DL PRS or SS/PBCH (Synchronization Signal/Physical Broadcast Channel) Block from a serving cell or a non-serving cell. The DL PRS may be configured to be QCL type C with an SS/PBCH Block from a serving cell or a non-serving cell. The start PRB parameter defines the starting PRB index of the DL PRS resource with respect to reference Point A. The starting PRB index has a granularity of one PRB and may have a minimum value of 0 and a maximum value of 2176 PRBs.

A PRS resource set is a collection of PRS resources with the same periodicity, same muting pattern configuration (if any), and the same repetition factor across slots. Every time all repetitions of all PRS resources of the PRS resource set are configured to be transmitted is referred as an “instance”. Therefore, an “instance” of a PRS resource set is a specified number of repetitions for each PRS resource and a specified number of PRS resources within the PRS resource set such that once the specified number of repetitions are transmitted for each of the specified number of PRS resources, the instance is complete. An instance may also be referred to as an “occasion.” A DL PRS configuration including a DL PRS transmission schedule may be provided to a UE to facilitate (or even enable) the UE to measure the DL PRS.

Multiple frequency layers of PRS may be aggregated to provide an effective bandwidth that is larger than any of the bandwidths of the layers individually. Multiple frequency layers of component carriers (which may be consecutive and/or separate) and meeting criteria such as being quasi co-located (QCLed), and having the same antenna port, may be stitched to provide a larger effective PRS bandwidth (for DL PRS and UL PRS) resulting in increased time of arrival measurement accuracy. Stitching comprises combining PRS measurements over individual bandwidth fragments into a unified piece such that the stitched PRS may be treated as having been taken from a single measurement. Being QCLed, the different frequency layers behave similarly, enabling stitching of the PRS to yield the larger effective bandwidth. The larger effective bandwidth, which may be referred to as the bandwidth of an aggregated PRS or the frequency bandwidth of an aggregated PRS, provides for better time-domain resolution (e.g., of TDOA). An aggregated PRS includes a collection of PRS resources and each PRS resource of an aggregated PRS may be called a PRS component, and each PRS component may be transmitted on different component carriers, bands, or frequency layers, or on different portions of the same band.

RTT positioning is an active positioning technique in that RTT uses positioning signals sent by TRPs to UEs and by UEs (that are participating in RTT positioning) to TRPs. The TRPs may send DL-PRS signals that are received by the UEs and the UEs may send SRS (Sounding Reference Signal) signals that are received by multiple TRPs. A sounding reference signal may be referred to as an SRS or an SRS signal. In 5G multi-RTT, coordinated positioning may be used with the UE sending a single UL-SRS for positioning that is received by multiple TRPs instead of sending a separate UL-SRS for positioning for each TRP. A TRP that participates in multi-RTT will typically search for UEs that are currently camped on that TRP (served UEs, with the TRP being a serving TRP) and also UEs that are camped on neighboring TRPs (neighbor UEs). Neighbor TRPs may be TRPs of a single BTS (e.g., gNB), or may be a TRP of one BTS and a TRP of a separate BTS. For RTT positioning, including multi-RTT positioning, the DL-PRS signal and the UL-SRS for positioning signal in a PRS/SRS for positioning signal pair used to determine RTT (and thus used to determine range between the UE and the TRP) may occur close in time to each other such that errors due to UE motion and/or UE clock drift and/or TRP clock drift are within acceptable limits. For example, signals in a PRS/SRS for positioning signal pair may be transmitted from the TRP and the UE, respectively, within about 10 ms of each other. With SRS for positioning signals being sent by UEs, and with PRS and SRS for positioning signals being conveyed close in time to each other, it has been found that radio-frequency (RF) signal congestion may result (which may cause excessive noise, etc.) especially if many UEs attempt positioning concurrently and/or that computational congestion may result at the TRPs that are trying to measure many UEs concurrently.

RTT positioning may be UE-based or UE-assisted. In UE-based RTT, the UE 200 determines the RTT and corresponding range to each of the TRPs 300 and the position of the UE 200 based on the ranges to the TRPs 300 and known locations of the TRPs 300. In UE-assisted RTT, the UE 200 measures positioning signals and provides measurement information to the TRP 300, and the TRP 300 determines the RTT and range. The TRP 300 provides ranges to a location server, e.g., the server 400, and the server determines the location of the UE 200, e.g., based on ranges to different TRPs 300. The RTT and/or range may be determined by the TRP 300 that received the signal(s) from the UE 200, by this TRP 300 in combination with one or more other devices, e.g., one or more other TRPs 300 and/or the server 400, or by one or more devices other than the TRP 300 that received the signal(s) from the UE 200.

Various positioning techniques are supported in 5G NR. The NR native positioning methods supported in 5G NR include DL-only positioning methods, UL-only positioning methods, and DL+UL positioning methods. Downlink-based positioning methods include DL-TDOA and DL-AoD. Uplink-based positioning methods include UL-TDOA and UL-AoA. Combined DL+UL-based positioning methods include RTT with one base station and RTT with multiple base stations (multi-RTT).

A position estimate (e.g., for a UE) may be referred to by other names, such as a location estimate, location, position, position fix, fix, or the like. A position estimate may be geodetic and comprise coordinates (e.g., latitude, longitude, and possibly altitude) or may be civic and comprise a street address, postal address, or some other verbal description of a location. A position estimate may further be defined relative to some other known location or defined in absolute terms (e.g., using latitude, longitude, and possibly altitude). A position estimate may include an expected error or uncertainty (e.g., by including an area or volume within which the location is expected to be included with some specified or default level of confidence).

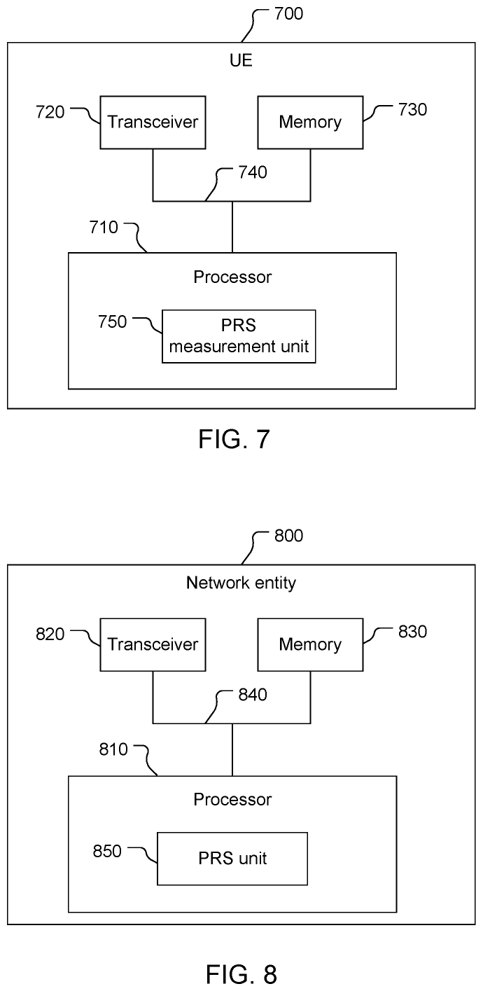

Referring also to FIG. 7, a UE 700 includes a processor 710, a transceiver 720, and a memory 730 communicatively coupled to each other by a bus 740. The UE 700 may include the components shown in FIG. 7. The UE 700 may include one or more other components such as any of those shown in FIG. 2 such that the UE 200 may be an example of the UE 700. For example, the processor 710 may include one or more of the components of the processor 210. The transceiver 720 may include one or more of the components of the transceiver 215, e.g., the wireless transmitter 242 and the antenna 246, or the wireless receiver 244 and the antenna 246, or the wireless transmitter 242, the wireless receiver 244, and the antenna 246. Also or alternatively, the transceiver 720 may include the wired transmitter 252 and/or the wired receiver 254. The memory 730 may be configured similarly to the memory 211, e.g., including software with processor-readable instructions configured to cause the processor 710 to perform functions.

The description herein may refer to the processor 710 performing a function, but this includes other implementations such as where the processor 710 executes software (stored in the memory 730) and/or firmware. The description herein may refer to the UE 700 performing a function as shorthand for one or more appropriate components (e.g., the processor 710 and the memory 730) of the UE 700 performing the function. The processor 710 (possibly in conjunction with the memory 730 and, as appropriate, the transceiver 720) includes a PRS measurement unit 750. The PRS measurement unit 750 is discussed further below, and the description may refer to the processor 710 generally, or the UE 700 generally, as performing any of the functions of the PRS measurement unit 750. The UE 700 is configured to perform the functions of the PRS measurement unit 750 discussed herein.

Referring also to FIG. 8, a network entity 800 includes a processor 810, a transceiver 820, and a memory 830 communicatively coupled to each other by a bus 840. The network entity 800 may include the components shown in FIG. 8. The network entity 800 may include one or more other components such as any of those shown in FIG. 3 and/or FIG. 4 such that the TRP 300 and/or the server 400 may be an example of the network entity 800. For example, the processor 810 may include one or more of the components of the processor 310 and/or the processor 410. The transceiver 820 may include one or more of the components of the transceiver 315 and/or the transceiver 415. The memory 830 may be configured similarly to the memory 311 and/or the memory 411, e.g., including software with processor-readable instructions configured to cause the processor 810 to perform functions.

The description herein may refer to the processor 810 performing a function, but this includes other implementations such as where the processor 810 executes software (stored in the memory 830) and/or firmware. The description herein may refer to the network entity 800 performing a function as shorthand for one or more appropriate components (e.g., the processor 810 and the memory 830) of the network entity 800 performing the function. The processor 810 (possibly in conjunction with the memory 830 and, as appropriate, the transceiver 820) includes a PRS unit 850. The PRS unit 850 is discussed further below, and the description may refer to the processor 810 generally, or the network entity 800 generally, as performing any of the functions of the PRS unit 850. The network entity 800 is configured to perform the functions of the PRS unit 850 discussed herein.

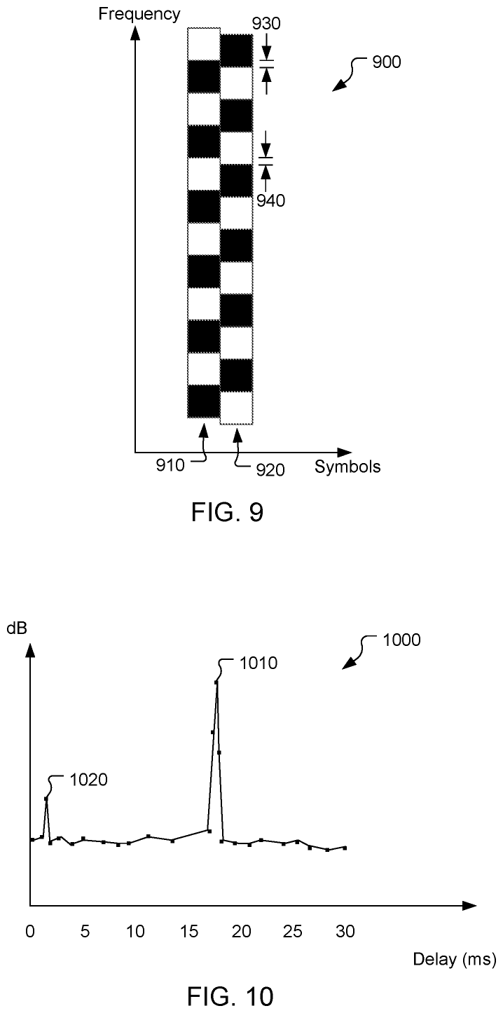

Referring also to FIG. 9, there may be frequency offset between symbols of a PRS resource 900, here a comb-2, 2-symbol resource. While one or more actions may be used to attempt to remove the frequency offset, some residual frequency offset between symbols is typically present (e.g., due to UE mobility and/or hardware limitation). The residual frequency offset, which is exaggerated in FIG. 9, causes resource elements in one symbol, e.g., a symbol 910, not to be aligned infrequency with resource elements in another symbol, e.g., a symbol 920. This misalignment in frequency between symbols of a PRS resource results in overlaps 930 of resource elements between the symbols 910, 920, and frequency gaps 940 between the symbols 910, 920. To avoid the effects of the residual frequency offset, PRS may be configured with a comb-1 transmission pattern, occupying every RE within the PRS bandwidth in a single symbol. Multiple PRS resources could be multiplexed within a slot using TDM (Time Division Multiplexing) and CDM (Code Division Multiplexing).

Referring also to FIG. 10, a frequency offset between symbols may result in measurement error. For example, ToA estimation algorithms for PRS typically implement threshold-based detection of the channel energy response (CER) to determine the ToA. The algorithms de-stagger the PRS by combining the tones (sounded REs, sounded tones) from all PRS symbols within a PRS resource and conducting a channel impulse response (CIR) and CER estimation, e.g., through an IFFT (Inverse Fast Fourier Transform) operation on the combined tones. Without a frequency offset between symbols, a CER 1000 may have a real peak 1010 that is a single, well-defined peak (well above any other peak in the CER 1000). The overlaps 930 and the frequency gaps 940 resulting from the residual frequency offset may, however, cause one or more aliased peaks, which may lead to incorrect measurement results. In the CER 1000, an aliased peak 1020 results from the residual frequency offset. The relative strength of the aliased peak 1020 and the real peak 1010 varies with the amount of frequency offset, with higher frequency offsets resulting in lower differences (fewer dB) between the real peak 1010 and the aliased peak 1020. The PRS provided by the network entity 800 and the processing by the UE 700 may reduce, or even overcome, the impact of the residual frequency offset on the CER, e.g., reducing or eliminating one or more aliased peaks from the CER (e.g., the aliased peak 1020), which may improve PRS measurement, e.g., ToA measurement, and accuracy of position estimation for the UE 700.

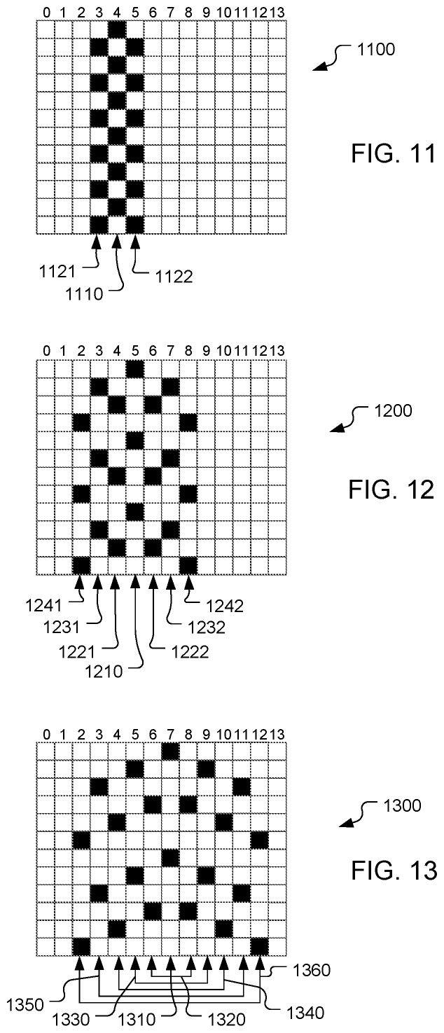

Referring also to FIGS. 11-13, the network entity 800, e.g., the PRS unit 850, may be configured to schedule and/or transmit a PRS resource with one or more symmetrical transmission patterns. The transmission patterns are symmetrical about a center symbol, and thus symmetrical in time, with the RE sounding patterns on either side of the center symbol being mirror images of each other. Thus, pairs of side symbols having symbols disposed on either side of the center symbol and with the same separation from the center symbol have the same REs sounded with the same content. For a comb-N PRS resource, the PRS unit 850 can schedule the PRS resource and N−1 additional symbols (at the beginning or the end of the PRS resource) to formulate a symmetric PRS resource with a center symbol and N−1 pairs of side symbols, e.g., as shown in FIGS. 11-13. For example, a transmission schedule 1100 shown in FIG. 11 is for a comb-2 PRS resource. The PRS unit 850 may schedule the PRS resource in symbols 3 and 4, and schedule an additional symbol (N−1=2−1=1 symbol) in symbol 5 with the identical resource element sounding pattern (transmission pattern) as the symbol in symbol 3 (or could instead add a symbol in symbol 2 with the same transmission pattern as the symbol in symbol 4). In this example, the transmission pattern includes a center symbol 1110 (also called a middle symbol) occupying symbol 4, and a single pair of side symbols 1121, 1122 occupying symbols 3 and 5. The PRS unit 850 schedules the pair of side symbols with identical resource element sounding patterns, with REs of the same subcarriers having the same content. As another example, a transmission schedule 1200 shown in FIG. 12 is for a comb-4 PRS resource. The PRS unit 850 may schedule the PRS resource in symbols 2-5, and schedule an additional three symbols (N−1=4−1=3 symbols) in symbols 6-8. In this example, the transmission pattern includes a center symbol 1210 occupying symbol 5, and three pairs of side symbols, i.e., a first pair of side symbols 1221, 1222 occupying symbols 4 and 6, a second pair of side symbols 1231, 1232 occupying symbols 3 and 7, and a third pair of side symbols 1241, 1242 occupying symbols 2 and 8. The PRS unit 850 schedules the symbols in each of the pairs of side symbols with identical resource element sounding patterns (with the same REs sounded), with REs of the same subcarriers having the same content. As another example, a transmission schedule 1300 shown in FIG. 13 is for a comb-6 PRS resource. The PRS unit 850 may schedule the PRS resource in symbols 2-7, and schedule an additional five symbols (N−1=6−1=5 symbols) in symbols 8-12. In this example, the transmission pattern includes a center symbol 1310 occupying symbol 7, and five pairs of side symbols, i.e., a first pair 1320 of side symbols occupying symbols 6 and 8, a second pair 1330 of side symbols occupying symbols 5 and 9, a third pair 1340 of side symbols occupying symbols 4 and 10, a fourth pair 1350 of side symbols occupying symbols 3 and 11, and a fifth pair 1360 of side symbols occupying symbols 2 and 12. The PRS unit 850 schedules the pairs 1320, 1330, 1340, 1350, 1360 of side symbols with identical resource element sounding patterns, with REs of the same subcarriers having the same content.

Other symmetrical transmission patterns may be used. For example, a comb-2transmission pattern with an odd integer number of symbols greater than three may be used. The number of comb-2 symbols may, for example, be five, seven, nine, or 11. As another example, a symmetrical transmission pattern may have gaps between symbols with sounded resource elements (i.e., may have symbols without sounded resource elements). In this case, symbols without resource elements sounded for the PRS will be symmetrically disposed about the center symbol. There may be multiple pairs of symbols without resource elements of the PRS in a transmission pattern. There may or may not be multiple consecutive symbols with resource elements of the PRS. A symmetrical transmission pattern may have a combination of consecutive symbols with PRS resource elements and one or more isolated symbols with PRS resource elements (e.g., with at least two symmetrical gaps between symbols having PRS resource elements, with no consecutive symbol with PRS resource elements, etc.). Still other symmetrical transmission patterns may be used. For example, odd comb numbers other than comb-3 may be used to provide a symmetrical transmission pattern.

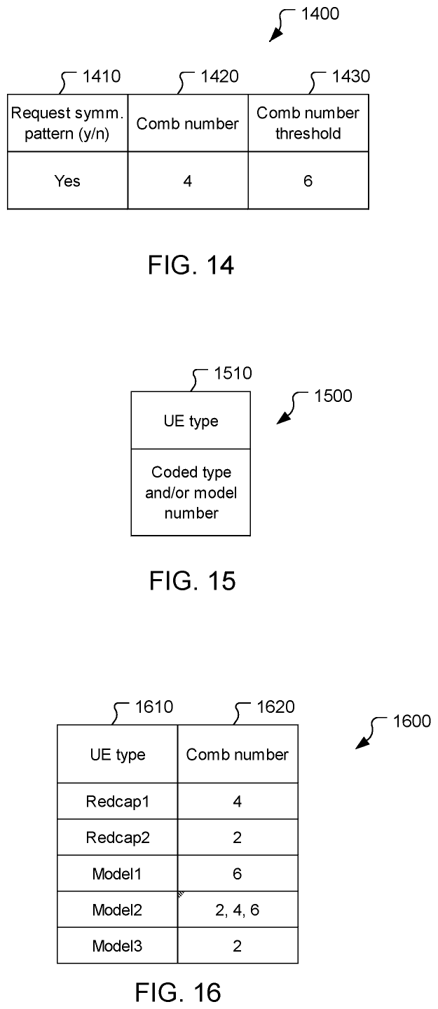

Referring also to FIG. 14, the UE 700, e.g., the PRS measurement unit 750, may be configured to request for the network entity 800 to schedule and/or provide a symmetric PRS transmission pattern, and the network entity 800, e.g., the PRS unit 850, may be configured to respond to the request by scheduling and/or transmitting a PRS resource with an appropriate PRS transmission pattern. For example, the UE 700 may be configured to send an explicit request 1400 via the transceiver to the network entity explicitly requesting a symmetric PRS transmission pattern generally. The explicit request 1400 may include a comb number field 1410 and/or a comb number threshold field 1420. With an explicit request for the symmetric PRS transmission pattern the UE 700 may explicitly request the comb number in the comb number field 1410 of the explicit request 1400, and/or may explicitly request a threshold comb number (such as a maximum comb number) in the comb number threshold field 1430. If the UE 700 requests a maximum comb number, the network entity 800 may schedule and/or transmit a PRS with that comb number or a lower comb number (e.g., if the UE 700 requests a maximum of comb-6, then the network entity 800 may schedule and/or transmit a PRS of comb-6, comb-4, or comb-2, along with the N−1 symbols to make the transmission pattern symmetric). The explicit request 1400 may include a comb number threshold and a comb number, e.g., to indicate comb numbers that the UE 700 supports while also requesting a preferred comb number for a symmetrical transmission pattern.

As another example, referring also to FIG. 15, the UE 700, e.g., the PRS measurement unit 750, may be configured to send an implicit request for a symmetric PRS transmission pattern to the network entity 800. For example, the UE 700 may be configured to send the network entity 800 an implicit request 1500 with a UE type field 1510 indicating of a type of the UE 700 (e.g., indicating that the UE 700 is a reduced-capability (red-cap) UE, indicating that the UE 700 is a specific kind of red-cap UE, and/or indicating a model number of the UE 700, etc.) and the network entity 800 may be configured to determine to schedule and/or transmit a symmetric PRS transmission pattern based on the indication of the type of the UE 700. For example, referring also to FIG. 16, the memory 830 may store a look-up table 1600 with a UE type field 1610 and a comb number field 1620 of UE types and comb numbers of transmission patterns, respectively, and the PRS unit 850 may be configured to find the UE type, determine the corresponding PRS transmission pattern, and schedule and/or transmit a PRS resource with corresponding the PRS transmission pattern. The network entity 800 may determine the comb number based on the indication of the UE type. For example, the comb number may be specified for the UE type. As another example, a range of acceptable (e.g., supported) comb numbers (e.g., comb-6 or lower) may be specified for the UE type and the PRS unit 850 may select from the range of acceptable comb numbers (e.g., selecting the acceptable comb number using the fewest symbols).

The UE 700, e.g., the PRS measurement unit 750, may be configured to process a PRS resource with a symmetric PRS transmission pattern using one or more combinations of symbols, which may reduce the impact of residual frequency offset in the PRS resource. For example, the PRS measurement unit 750) may combine the side symbol 1121 with the side symbol 1122, e.g., averaging the side symbols 1121, 1122 in the time domain, to determine a combined symbol (with the transmission pattern of the side symbols 1121, 1122 but with a frequency offset of an average of the frequency offsets of the side symbols 1121, 1122). If the resource offset is consistent from symbol to symbol, then the combined symbol will have zero frequency offset relative to the center symbol 1110, such that processing the combined symbol with the center symbol will reduce if not eliminate, the impact of the residual frequency offset on a measurement of the PRS resource (and on other position information based on the measurement). The PRS measurement unit 750) may perform an FFT on the combined symbol and the center symbol 1110 to produce a transformed combined symbol and a transformed center symbol. The PRS measurement unit 750) may combine the transformed combined symbol and the transformed center symbol to de-stagger the PRS resource to produce a de-staggered PRS resource. The PRS measurement unit 750 may perform an IFFT on the de-staggered PRS resource to produce an inverted resource and determine a CIR/CER estimation using the inverted resource. The PRS measurement unit 750 may determine the ToA from the CIR/CER peak(s). The PRS measurement unit 750) may be configured to process other symmetric PRS transmission patterns in a similar manner to determine a PRS measurement with reduced residual frequency offset impact. The PRS measurement unit 750) may combine each of multiple pairs of side symbols to produce multiple combined symbols that the PRS measurement unit 750) may combine with the center symbol. For example, the PRS measurement unit 750 may combine (e.g., average) the side symbols 1221, 1222, combine the side symbols 1231, 1232, and combine the side symbols 1241, 1242 to produce three combined symbols that the PRS measurement unit 750 may combine (e.g., after performing an FFT on each of the combined symbols and the center symbol 1210) with the center symbol 1210 to produce a de-staggered PRS resource. Similarly, the PRS measurement unit 750) may combine (e.g., average) symbols of each of the pairs 1320, 1330, 1340, 1350, 1360, respectively, to produce five combined symbols that the PRS measurement unit 750) may combine with the center symbol 1310 to produce a de-staggered PRS resource. Similar to the discussion above, the PRS measurement unit may perform an IFFT on the de-staggered PRS resource to produce an inverted PRS resource, determine the CIR/CER estimation from the inverted PRS resource, and determine the ToA from the CIR/CER estimation.

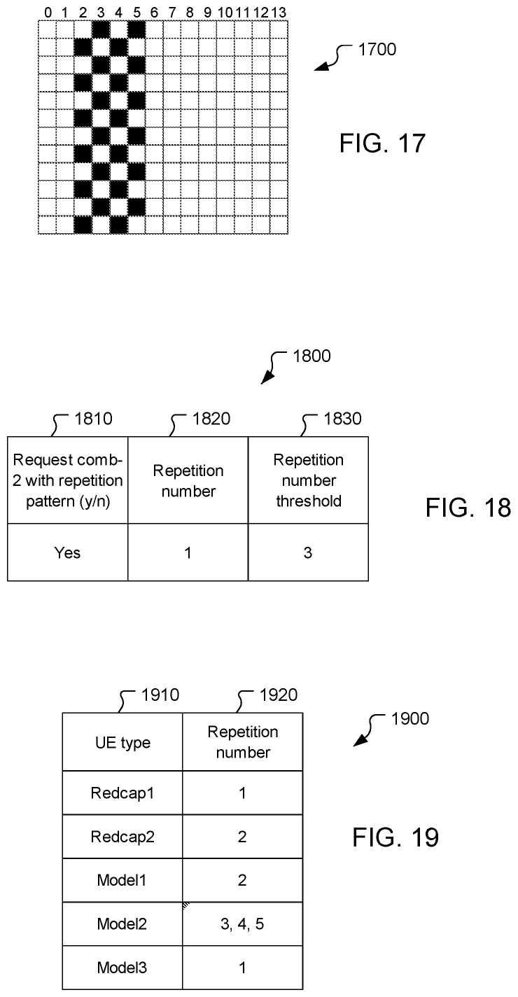

Referring also to FIG. 17, with further reference in particular to FIGS. 6G and 6C, the network entity 800, e.g., the PRS unit 850, may be configured to schedule and/or transmit a comb-2 PRS resource with one or more consecutive repetitions. The one or more repetitions is (are) consecutive in that the repetition(s) follow the PRS resource without any symbol gap between the PRS resource and the first repetition or between one repetition and the next repetition (if any). For example, as shown in FIG. 17, the PRS unit 850 may be configured to schedule and/or transmit a comb-2, 2-symbol PRS resource with a transmission pattern 1700 that has four consecutive symbols, with the PRS resource in symbols 2 and 3, and a repetition of the PRS resource in symbols 4 and 5. As another example, as shown in FIG. 6G, the PRS unit 850 may be configured to schedule and/or transmit a comb-2, 2-symbol PRS resource and two repetitions with a PRS transmission pattern that has six consecutive symbols, with the PRS resource in symbols 2 and 3, and repetitions of the PRS resource in symbols 4 and 5, and in symbols 6 and 7, respectively. As another example, as shown in FIG. 6C, the PRS unit 850 may be configured to schedule and/or transmit a comb-2, 2-symbol PRS resource and five repetitions with a PRS transmission pattern that has 12 consecutive symbols, with the PRS resource in symbols 2 and 3, and repetitions of the PRS resource in symbols 4 and 5, symbols 6 and 7, symbols 8 and 9, symbols 10 and 11, and symbols 12 and 13, respectively.

Referring also to FIG. 18, the UE 700, e.g., the PRS measurement unit 750, may be configured to transmit an explicit request 1800 for the network entity 800 to schedule and/or provide a comb-2 PRS resource with at least one consecutive repetition, and the network entity 800, e.g., the PRS unit 850, may be configured to respond to the explicit request 1800 by scheduling and/or transmitting a PRS resource with an appropriate PRS transmission pattern. For example, the UE 700 may be configured to send the explicit request 1800, including request comb-2 with repetition pattern field 1810, a repetition number field 1820, and/or a repetition number threshold field 1830, via the transceiver 720 to the network entity 800 explicitly requesting a comb-2 PRS resource with at least one consecutive repetition. With the explicit request 1800 for the comb-2 PRS transmission pattern with at least one repetition, the UE 700 may explicitly request a quantity of repetitions using the repetition number field 1820, and/or may explicitly request a threshold quantity of repetitions using the repetition number threshold field 1830. If the UE 700 requests a threshold quantity of repetitions, the network entity 800 may schedule and/or transmit a PRS with at least that quantity of repetitions (e.g., if the UE 700 requests at least one repetition, then the network entity 800 may schedule and/or transmit a comb-2 PRS with one repetition, two repetitions, etc.).

As another example, the UE 700, e.g., the PRS measurement unit 750, may be configured to send an implicit request to the network entity 800 for a comb-2 PRS transmission pattern with one or more repetitions. For example, the UE 700 may be configured to send the network entity 800 in implicit request (e.g., the implicit request 1500) indicating a type of the UE 700 (e.g., indicating that the UE 700 is a reduced-capability (red-cap) UE, indicating that the UE 700 is a specific kind of red-cap UE, and/or indicating a model number of the UE 700, etc.) and the network entity 800 may be configured to determine to schedule and/or transmit a comb-2 PRS resource with a PRS transmission pattern with at least one repetition based on the indication of the type of the UE 700. For example, the memory 830 may store a look-up table 1900 with a UE type field 1910 and a repetition number field 1920 of UE types and repetition quantities for comb-2 transmission patterns and the PRS unit 850 may be configured to find the UE type, determine the corresponding PRS transmission pattern (repetition quantity), and schedule and/or transmit a PRS resource with corresponding the PRS transmission pattern. The network entity 800 may determine the quantity of repetitions based on the indication of the UE type. For example, the repetition quantity may be specified for the UE type. As another example, a range of acceptable (e.g., supported) repetition quantities (e.g., between two and five) may be specified for the UE type and the PRS unit 850 may select from the range of acceptable repetition quantities (e.g., selecting the smallest acceptable repetition quantity).

The network entity 800 may be implicitly requested for a comb-2 PRS

transmission pattern with one or more repetitions without the UE 700 sending request to the network entity 800. For example, the network entity 800 may be configured to respond to the network entity 800 requesting position information (e.g., a PRS measurement and/or a processed PRS measurement (e.g., a pseudorange, a position estimate) from the UE 700 and the UE 700 not providing the position information, or not providing the position information with desired accuracy, by scheduling and/or transmitting a comb-2 PRS resource with one or more repetitions. The network entity may determine how many repetitions to schedule and/or transmit based on one or more of a variety of factors, e.g., UE type, other signals to be scheduled/transmitted, potential for collisions, urgency of position information, etc.

The UE 700, e.g., the PRS measurement unit 750, may be configured to process a PRS comprising a comb-2 PRS resource with one or more repetitions by dividing the PRS into multiple symmetrical transmission sub-patterns and processing the multiple sub-patterns of the PRS. For example, the PRS measurement unit 750 may divide the transmission pattern 1700 into a first sub-pattern of symbols 2-4 and a second sub-pattern of symbols 3-5. As another example, the PRS measurement unit 750 may divide the transmission schedule 614 into symmetrical sub-patterns of three or five symbols, e.g., two or more sub-patterns of the symbols 2-4, 3-5, 4-6, 5-7 and/or one or more sub-patterns of symbols 2-6, 3-7. As another example, the PRS measurement unit 750 may divide the transmission schedule 606 into symmetrical sub-patterns of three, five, seven, or nine symbols, e.g., two or more sub-patterns of the symbols 2-4, 3-5, 4-6, 5-7, 6-8, 7-9, 8-10, 9-11, 10-12, 11-13 and/or one or more sub-patterns of symbols 2-6, 3-7, 4-8, 5-9, 6-10, 7-11, 8-12, 9-13 and/or one or more sub-patterns of symbols 2-8, 3-9, 4-10, 5-11, 6-12, 7-13 and/or one or more sub-patterns of symbols 2-10, 3-11, 4-12, 5-13 and/or one or more sub-patterns of symbols 2-12, 3-13. In any of these examples, the PRS measurement unit 750 may process two or more selected sub-patterns of the available sub-patterns by processing each of the selected sub-patterns as discussed above, combining each pair side symbols with identical resource element sounding patterns to produce one or more combined symbols, combining the combined symbol(s) with the center symbol to determine a de-staggered symbol, and using the de-staggered symbol to determine position information (e.g., a PRS measurement such as ToA) from which further position information may be determined, and combining the determine position information (e.g., averaging determined ToAs).

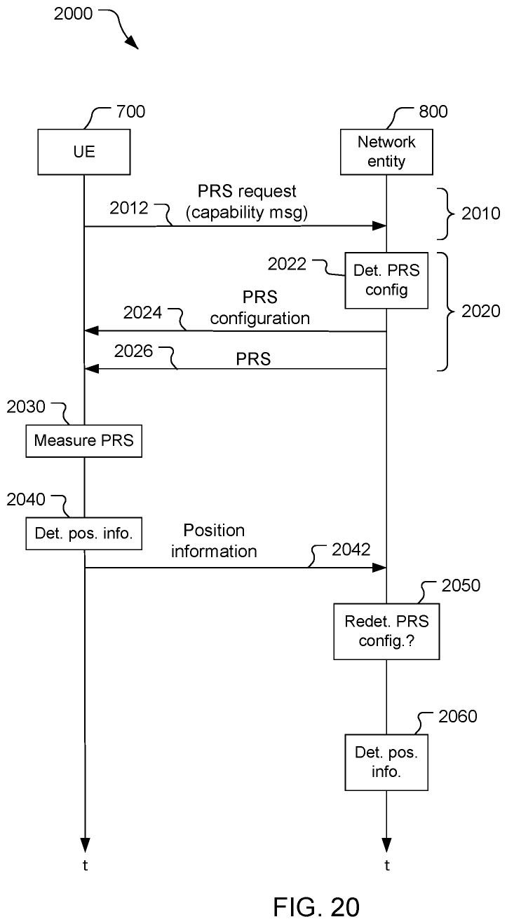

Referring to FIG. 20, with further reference to FIGS. 1-19, a timing diagram shows a signaling and process flow 2000 scheduling and using an enhanced positioning reference signal to determine position information includes the stages shown. The signaling and process flow 2000 is an example, and the signaling and process flow 2000 may be altered, e.g., by adding one or more stages, removing one or more stages, and/or rearranging one or more of the stages shown.

At stage 2010, the UE 700 transmits a PRS request 2012 to the network entity 800. The PRS request 2012 may be an explicit request for an enhanced PRS configuration. For example, the PRS request 2012 may request a symmetrical PRS transmission pattern or a comb-2 PRS with at least one repetition transmission pattern. The PRS request 2012 may comprise an explicit request, e.g., the explicit request 1400 or the explicit request 1800. As another example, the PRS request 2012 may comprise an implicit request such as the implicit request 1500.

At stage 2020, the network entity 800 determines a PRS configuration for enhanced PRS and transmits the PRS configuration and PRS to the UE 700. For example, at sub-stage 2022, the network entity 800 determines the PRS configuration. For example, the server 400 and the TRP 300 may negotiate to determine, or the server 400 or the TRP 300 may independently determine, the PRS configuration based on the PRS request 2012 (e.g., to implement an explicitly or implicitly requested parameter, or to select (e.g., from a look-up table such as the look-up table 1600 or the look-up table 1900) a parameter from possible parameters explicitly or implicitly indicated by the PRS request 2012 and to implement the selected parameter). The network entity 800 transmits a PRS configuration 2024 determined at sub-stage 2022 to the UE 700 (e.g., the TRP 300 transmits the PRS configuration 2024 directly to the UE 700 or the network entity 800 transmits the PRS configuration 2024 to the UE 700 via the TRP 300). The network entity 800 (e.g., the TRP 300) transmits a PRS 2026 to the UE 700 in accordance with the PRS configuration 2024. The PRS configuration 2024 and/or the PRS 2026 may constitute an implicit request for the UE 700 to measure the PRS 2026 or may include an explicit request for the UE 700 to measure the PRS 2026 and report position information (e.g., one or more PRS measurements and/or one or more processed PRS measurements).

At stage 2030, the UE 700 measures the PRS 2026. For example, the PRS measurement unit 750 combines one or more pairs of symbol with identical resource element sounding patterns to determine one or more combined symbols, combines the combined symbol(s) with a center symbol to determine a de-staggered symbol, and determines a PRS measurement (e.g., ToA) from the de-staggered symbol. The PRS measurement unit 750 may determine multiple de-staggered symbols and multiple PRS measurements, that the PRS measurement unit 750 may combine (e.g., average), depending on the PRS transmission pattern (e.g., if the PRS transmission pattern is a comb-2 transmission pattern with at least one repetition.

At stage 2040, the UE 700, e.g., the PRS measurement unit 750, determines position information. The position information may be the measurement determined at stage 2030 (and thus the stage 2030 and the stage 2040 may be one stage). Alternatively, the UE 700 may determine further position information based on a PRS measurement, e.g., a pseudorange, a position estimate for the UE 700, etc. The UE 700 may transmit position information 2042 (e.g., a PRS measurement and/or a processed PRS measurement (e.g., a pseudorange and/or a position estimate)) to the network entity 800. The UE 700 may transmit the position information 2042 with an indication of accuracy (e.g., measurement accuracy, position estimation accuracy). The UE 700 may not transmit the position information 2042 unless the position information meets one or more criteria such as a threshold accuracy. Instead of determining and transmitting position information to the network entity 800, the UE 700 may transmit raw measurement information to the network entity 800 and the network entity 800 may determine the measurement information (e.g., combining the symbols with identical resource element sounding patterns, determining the de-staggered symbol(s), and determining the measurement(s) and the combined measurement (if multiple measurements corresponding to multiple de-staggered symbols are determined)). In this case, the UE 700 may request enhanced PRS (e.g., symmetrical PRS transmission pattern or comb-2 PRS with at least one repetition) and provide raw measurement information to the network entity 800 without the UE 700 determining one or more measurements by combining one or more symbols of identical resource element sounding pattern.

At stage 2050, the network entity 800 determines whether to redetermine the PRS configuration. For example, if the position information 2042 includes an indication of accuracy and the accuracy is below a desired accuracy (e.g., below a threshold accuracy), then the signaling and process flow 2000 may return to sub-stage 2022 for the network entity to redetermine the PRS configuration 2024 (e.g., to add one or more repetitions to a comb-2 PRS transmission pattern with at least one repetition, or to change a comb number of a symmetrical PRS transmission pattern). As another example, if the position information 2042 is not received in response to an explicit or implicit request for the position information 2042 (e.g., within a threshold amount of time after transmission of the PRS 2026), then the signaling and process flow 2000 may return to sub-stage 2022 for the network entity to redetermine the PRS configuration 2024.

At stage 2060, the network entity 800 may determine position information. For example, the network entity 800 may use some or all of the position information 2042 to determine a position estimate for the UE 700.

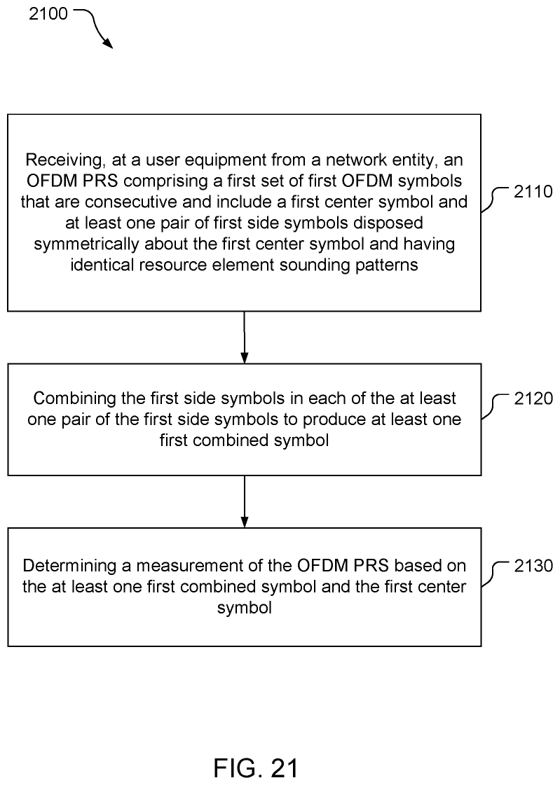

Referring to FIG. 21, with further reference to FIGS. 1-20, a positioning reference signal measurement method 2100 includes the stages shown. The method 2100 is, however, an example and not limiting. The method 2100 may be altered, e.g., by having stages added, removed, rearranged, combined, performed concurrently, and/or having single stages split into multiple stages.

At stage 2110, the method 2100 includes receiving, at a user equipment from a network entity, an OFDM PRS comprising a first set of first OFDM symbols that are consecutive and include a first center symbol and at least one pair of first side symbols disposed symmetrically about the first center symbol and having identical resource element sounding patterns. For example, the UE 700 receives the PRS 2026 at stage 2020. The PRS may be, for example, a symmetric PRS with a symmetrical transmission pattern such as any of the transmission schedules 1100, 1200, 1300 or another symmetrical transmission schedule. As another example, the PRS may be a comb-2 PRS with at least one repetition such as any of the transmission schedules 606, 614, 1700, or another transmission schedule. The processor 710, possibly in combination with the memory 730, in combination with the transceiver 720 (e.g., the wireless receiver 244 and the antenna 246) may comprise means for receiving the OFDM PRS.

At stage 2120, the method 2100 includes combining the first side symbols in each of the at least one pair of the first side symbols to produce at least one first combined symbol. For example, at stage 2030, the PRS measurement unit 750 combines (e.g., averages) pairs of symbols of the PRS 2026 in the time domain where the symbols in each pair have the same resource element sounding pattern (transmission pattern) and are symmetrically disposed in time relative to a center symbol about which the transmission pattern of the PRS is symmetrical. The symbols in a pair of symbols may each be one symbol away from the center symbol (e.g., the side symbols 1121, 1122 relative to the center symbol 1110, or the side symbols 1221, 1222 relative to the center symbol 1210, or symbols 2 and 4 relative to symbol 3 in FIG. 17, or symbols 3 and 5 relative to symbol 4 in FIG. 17), two symbols away from the center symbol (e.g., the side symbols 1231, 1232 relative to the center symbol 1210), etc., with the number of symbols away from the center symbol being the same for both symbols in the pair. By combining pairs of side symbols symmetrically disposed relative to the center symbol, the combined symbol(s) and the center symbol will have the same, or nearly the same, frequency offset and thus zero, or nearly zero, relative frequency offset, which will reduce or eliminate effects of residual frequency offset on position information determined from the PRS 2026. The processor 710, possibly in combination with the memory 730), may comprise means for combining the first side symbols.

At stage 2130, the method 2100 includes determining a measurement of the OFDM PRS based on the at least one first combined symbol and the first center symbol. For example, at stage 2030 the PRS measurement unit 750) determines a PRS measurement, e.g., ToA, using the combined pair(s) of side symbols and the respective center symbol(s). By determining the PRS measurement from the combined pair(s) of side symbols and the center symbol, the effects of residual frequency offset may be reduced or eliminated, thus improving accuracy of position information determined from the PRS 2026 relative to determining the position information without combining side pairs of symbols. The processor 710, possibly in combination with the memory 730, may comprise means for determining the measurement of the OFDM PRS.

Implementations of the method 2100 may include one or more of the following features. In an example implementation, the method 2100 further includes transmitting, from the user equipment to the network entity, a request for the OFDM PRS to consist of a symmetric transmission pattern. For example, the UE 700 transmits the explicit request 1400 or the explicit request 1800 or the implicit request 1500 to the network entity 800. This may help ensure accurate measurement of the PRS by the UE 700 while possibly limiting overhead between the UE 700 and the network entity 800 to request a PRS for enhanced processing to help ensure accurate measurement. The request may indicate an odd integer quantity of symbols for the PRS 2026 to contain in a slot. The processor 710, possibly in combination with the memory 730, in combination with the transceiver 720 (e.g., the wireless transmitter 242 and the antenna 246) may comprise means for transmitting the request for the OFDM PRS to consist of a symmetric transmission pattern. In a further example implementation, the request includes an indication of a threshold value of a comb number of the OFDM PRS. For example, the explicit request 1400 may include the comb number threshold field 1430. This may help ensure accurate measurement of the PRS by the UE 700 while possibly allowing the network entity to select a comb number, e.g., to help avoid collisions of the PRS with one or more other signals. In another further example implementation, the request includes an indication of a type of the user equipment. For example, the UE 700 may transmit the implicit request 1500 to the network entity 800. This may conserve overhead traffic between the UE 700 and the network entity 800 while allowing for enhanced PRS scheduling/transmission and/or processing to improve positioning accuracy.

Also or alternatively, implementations of the method 2100 may include one or more of the following features. In an example implementation, the method 2100 further includes transmitting, from the user equipment to the network entity, a request for the OFDM PRS to comprise a comb-2, 2-symbol resource with at least one consecutive repetition. For example, the UE 700 transmits the explicit request 1800 or the implicit request 1500 to the network entity 800. For example, an indication of the UE 700 being a reduced capability UE may implicitly request a comb-2 PRS resource with one or more repetitions. This may help ensure accurate measurement of the PRS by the UE 700 while possibly limiting overhead between the UE 700 and the network entity 800 to request a PRS for enhanced processing to help ensure accurate measurement. The processor 710, possibly in combination with the memory 730, in combination with the transceiver 720 (e.g., the wireless transmitter 242 and the antenna 246) may comprise means for transmitting the request for the OFDM PRS to comprise a comb-2, 2-symbol resource with at least one consecutive repetition. In a further example implementation, the request includes an indication of a threshold quantity of the at least one consecutive repetition. For example, the explicit request 1800 may include the repetition number threshold. This may help ensure accurate measurement of the PRS by the UE 700 while possibly allowing the network entity to select a repetition number, e.g., to help avoid collisions of the PRS with one or more other signals and/or to use resource elements for transmitting other signals. In another further example implementation, the request includes an indication of a type of the user equipment. For example, the implicit request 1500 may include an indication of the type of the UE 700 which the network entity 800 may use to determine to use a comb-2, 2-symbol PRS resource with one or more repetitions, and may use to determine the quantity of the one or more repetitions. This may help ensure accurate measurement of the PRS by the UE 700 while possibly limiting overhead between the UE 700 and the network entity 800.

Also or alternatively, implementations of the method 2100 may include one or more of the following features. In an example implementation, the OFDM PRS comprises a comb-2, 2-symbol resource with at least one consecutive repetition such that the OFDM PRS comprises the first set of the first OFDM symbols and at least one second set of second OFDM symbols that are consecutive with the first set of the first OFDM symbols, with at least one of the first OFDM symbols being different from the second OFDM symbols and the second OFDM symbols of each of the at least one second set of the second OFDM symbols including a second center symbol and at least one pair of second side symbols disposed symmetrically in time about the second center symbol and having identical resource element sounding patterns, wherein the measurement of the OFDM PRS is a first measurement of the OFDM PRS, and wherein the positioning reference signal measurement method further comprises, for each of the at least one second set of the second OFDM symbols: combining the second side symbols in each of the at least one pair of the second side symbols to produce at least one second combined symbol; and determining at least one second measurement of the OFDM PRS based on the at least one second combined symbol and the second center symbol of each of the at least one second set of the second OFDM symbols. For example, the PRS measurement unit 750) may select and process multiple symmetrical sets of symbols of a comb-2, 2-symbol PRS with one or more repetitions. The sets may include various quantities (e.g., three, five, or seven) of symbols depending on the quantity of repetitions (e.g., including more than one repetition), and the PRS measurement unit 750 may select all or fewer than all available symmetric sets for processing to reduce/remove the effects of the residual frequency offset as discussed herein. This may help reduce/remove residual frequency offset effects and improve measurement accuracy. Multiple combined symbols may be determined and used with the center symbol to determine a de-staggered symbol. More than two de-staggered symbols may be determined, as well as more than two corresponding measurements. The processor 710, possibly in combination with the memory 730, may comprise means for combining the second side symbols and means for determining the at least one second measurement of the OFDM PRS. In a further example implementation, the method 2100 further includes combining the first measurement of the OFDM PRS and the at least one second measurement of the OFDM PRS to determine a composite measurement of the OFDM PRS. For example, two (or more) measurements (e.g., ToAs) may be averaged, which may improve the accuracy of the ToA. The processor 710, possibly in combination with the memory 730, may comprise means for combining the first measurement of the OFDM PRS and the at least one second measurement of the OFDM PRS.

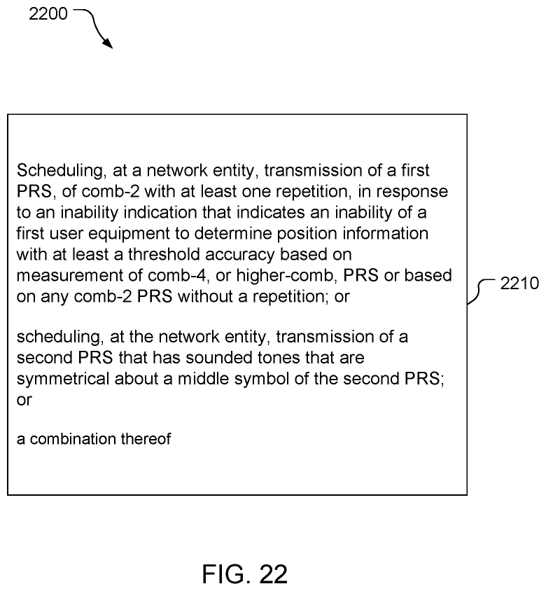

Referring to FIG. 22, with further reference to FIGS. 1-20, a positioning reference signal scheduling method 2200 includes the stage shown. The method 2200 is, however, an example and not limiting. The method 2200 may be altered, e.g., by having stages added or having the stage shown split into multiple stages.

At stage 2210, the method 2200 includes scheduling, at a network entity, transmission of a first PRS, of comb-2 with at least one repetition, in response to an inability indication that indicates an inability of a first user equipment to determine position information with at least a threshold accuracy based on measurement of comb-4, or higher-comb, PRS or based on any comb-2 PRS without a repetition; or scheduling, at the network entity, transmission of a second PRS that has sounded tones that are symmetrical about a middle symbol of the second PRS; or a combination thereof. For example, the network entity 800 (e.g., the TRP 300 and the server 400) may determine (e.g., negotiate) at sub-stage 2022 comb-2 PRS transmission pattern with one or more repetitions if the UE 700 is unable to determine position information (e.g., a PRS measurement, a pseudorange, a position estimate) with a desired level of accuracy if the PRS is comb-4 or higher, or if the PRS is comb-2 without any repetition. Also or alternatively, the network entity 800 (e.g., the TRP 300 and the server 400) may determine (e.g., negotiate) at sub-stage 2022 a symmetrical PRS transmission pattern, or the network entity 800 (e.g., the TRP 300) may transmit a symmetrical PRS transmission pattern as the PRS configuration 2024. The symmetrical PRS may have an odd integer quantity of symbols with sounded resource elements, with the symbols being consecutive or non-consecutive. The processor 810 (e.g., the processor 310 and/or the processor 410), possibly in combination with the memory 830 (e.g., the memory 311 and/or the memory 411), possibly in combination with the transceiver 820 (e.g., the transceiver 315 (e.g., the wireless transmitter 342 and/or the wireless receiver 344, and the antenna 346) and/or the transceiver 415 (e.g., the wired transmitter 452 and/or the wired receiver 454)) may comprise means for scheduling transmission of the first PRS and/or means for scheduling transmission of the second PRS.

Implementations of the method 2200 may include one or more of the following features. In an example implementation, the method 2200 includes scheduling transmission of the second PRS based on receiving a request, at the network entity, from a second user equipment for the second PRS. For example, the PRS unit 850 may schedule symmetrical PRS in response to the explicit request 1400 or the implicit request 1500. In a further example implementation, scheduling transmission of the second PRS includes scheduling transmission of the second PRS such that the second PRS consists, within a slot, of 2N−1 consecutive symbols where N is a comb number indicated in the request. In another further example implementation, the request comprises: one or more explicit indications of one or more parameters of the second PRS; or an implicit indication of the one or more parameters of the second PRS. For example, the request may be the explicit request 1400 and indicate the comb number or comb number threshold (or another parameter, e.g., number of symbols). As another example, the request may be the implicit request 1500 and may correspond to one or more parameters, e.g., in the look-up table 1600 or another look-up table or another relationship between implicit request and the parameter(s).

Also or alternatively, implementations of the method 2200 may include one or more of the following features. In an example implementation, the method 2200 includes scheduling transmission of the first PRS, where the inability indication indicates a type of the first user equipment to indicate, implicitly, the inability of the first user equipment to determine position information with at least the threshold accuracy based on PRS of comb-4 or higher, or based on comb-2 PRS without a repetition, and where the method 2200 further includes determining, at the network entity, a quantity of repetitions of the at least one repetition based on the type of the first user equipment. For example, the UE 700 may send the implicit request 1500 which implicitly indicates that the UE 700 is unable to provide position information with sufficient accuracy (e.g., based on a look-up table of UE type and position information accuracy) based on anything but comb-2 PRS with one or more repetitions, and the network entity 800 may determine a quantity of repetitions based on the UE type, e.g., using the look-up table 1900 or another relationship of UE type to repetition quantity. The network entity 800 may also use one or more other criteria, e.g., to use the fewest symbols that will allow the UE 700 to provide sufficient position information accuracy. The processor 810, possibly in combination with the memory 820, may comprise means for determining the quantity of repetitions. In another example implementation, the method 2200 includes scheduling transmission of the first PRS with a quantity of the at least one repetition corresponding to an explicit quantity indication in the inability indication. For example, the network entity 800 may schedule comb-2 PRS with the same quantity of repetition indicated in the repetition number field 1820 of the explicit request 1800.

Still other features of implementations of the method 2200 may be used. For example, the network entity 800 may respond to an implicit indication of a UE inability to measure previously-transmitted PRS with at least a desired level of accuracy by scheduling symmetrical PRS or comb-2 PRS with one or more repetitions. For example, at stage 2050, the network entity 800 may determine that the position information 2042 is insufficiently accurate, or that no requested position information has been provided by the UE 700. In response, the network entity 800 may determine to transmit symmetrical PRS or comb-2 PRS with one or more repetitions.

### Implementation Examples

Implementation examples are provided in the following numbered clauses.

Clause 1. A user equipment comprising:
a transceiver;
a memory; and
a processor, communicatively coupled to the memory and the transceiver, configured to:
   receive, via the transceiver from a network entity, an OFDM PRS (orthogonal frequency division multiplexing positioning reference signal) comprising a first set of first OFDM symbols that are consecutive and include a first center symbol and at least one pair of first side symbols disposed symmetrically about the first center symbol and having identical resource element sounding patterns;
   combine the first side symbols in each of the at least one pair of first side symbols to produce at least one first combined symbol; and
   determine a measurement of the OFDM PRS based on the at least one first combined symbol and the first center symbol.

Clause 2. The user equipment of clause 1, wherein the processor is configured to transmit, via the transceiver to the network entity, a request for the OFDM PRS to consist of a symmetric transmission pattern.

Clause 3. The user equipment of clause 2, wherein the request comprises an indication of a threshold value of a comb number of the OFDM PRS.

Clause 4. The user equipment of clause 2, wherein the request comprises an indication of a type of the user equipment.

Clause 5. The user equipment of clause 1, wherein the processor is configured to transmit, via the transceiver to the network entity, a request for the OFDM PRS to comprise a comb-2, 2-symbol resource with at least one consecutive repetition.

Clause 6. The user equipment of clause 5, wherein the request comprises an indication of a threshold quantity of the at least one consecutive repetition.

Clause 7. The user equipment of clause 5, wherein the request comprises an indication of a type of the user equipment.

Clause 8. The user equipment of clause 1, wherein the OFDM PRS comprises a comb-2, 2-symbol resource with at least one consecutive repetition such that the OFDM PRS comprises the first set of first OFDM symbols and at least one second set of second OFDM symbols that are consecutive with the first set of first OFDM symbols, with at least one of the first OFDM symbols being different from the second OFDM symbols and the second OFDM symbols of each of the at least one second set of second OFDM symbols including a second center symbol and at least one pair of second side symbols disposed symmetrically in time about the second center symbol and having identical resource element sounding patterns, wherein the measurement of the OFDM PRS is a first measurement of the OFDM PRS, and wherein the processor is configured to, for each of the at least one second set of second OFDM symbols:
combine the second side symbols in each of the at least one pair of second side symbols to produce at least one second combined symbol; and
determine at least one second measurement of the OFDM PRS based on the at least one second combined symbol and the second center symbol of each of the at least one second set of second OFDM symbols.

Clause 9. The user equipment of clause 8, wherein the processor is configured to combine the first measurement of the OFDM PRS and the at least one second measurement of the OFDM PRS to determine a composite measurement of the OFDM PRS.

Clause 10. A positioning reference signal measurement method comprising:
receiving, at a user equipment from a network entity, an OFDM PRS (orthogonal frequency division multiplexing positioning reference signal) comprising a first set of first OFDM symbols that are consecutive and include a first center symbol and at least one pair of first side symbols disposed symmetrically about the first center symbol and having identical resource element sounding patterns;
combining the first side symbols in each of the at least one pair of first side symbols to produce at least one first combined symbol; and
determining a measurement of the OFDM PRS based on the at least one first combined symbol and the first center symbol.

Clause 11. The positioning reference signal measurement method of clause 10, further comprising transmitting, from the user equipment to the network entity, a request for the OFDM PRS to consist of a symmetric transmission pattern.

Clause 12. The positioning reference signal measurement method of clause 11, wherein the request comprises an indication of a threshold value of a comb number of the OFDM PRS.

Clause 13. The positioning reference signal measurement method of clause 11, wherein the request comprises an indication of a type of the user equipment.

Clause 14. The positioning reference signal measurement method of clause 10, further comprising transmitting, from the user equipment to the network entity, a request for the OFDM PRS to comprise a comb-2, 2-symbol resource with at least one consecutive repetition.

Clause 15. The positioning reference signal measurement method of clause 14, wherein the request comprises an indication of a threshold quantity of the at least one consecutive repetition.

Clause 16. The positioning reference signal measurement method of clause 14, wherein the request comprises an indication of a type of the user equipment.

Clause 17. The positioning reference signal measurement method of clause 10, wherein the OFDM PRS comprises a comb-2, 2-symbol resource with at least one consecutive repetition such that the OFDM PRS comprises the first set of first OFDM symbols and at least one second set of second OFDM symbols that are consecutive with the first set of first OFDM symbols, with at least one of the first OFDM symbols being different from the second OFDM symbols and the second OFDM symbols of each of the at least one second set of second OFDM symbols including a second center symbol and at least one pair of second side symbols disposed symmetrically in time about the second center symbol and having identical resource element sounding patterns, wherein the measurement of the OFDM PRS is a first measurement of the OFDM PRS, and wherein the positioning reference signal measurement method further comprises, for each of the at least one second set of second OFDM symbols:
combining the second side symbols in each of the at least one pair of second side symbols to produce at least one second combined symbol; and
determining at least one second measurement of the OFDM PRS based on the at least one second combined symbol and the second center symbol of each of the at least one second set of second OFDM symbols.

Clause 18. The positioning reference signal measurement method of clause 17, further comprising combining the first measurement of the OFDM PRS and the at least one second measurement of the OFDM PRS to determine a composite measurement of the OFDM PRS.

Clause 19. A user equipment comprising:
means for receiving, from a network entity, an OFDM PRS (orthogonal frequency division multiplexing positioning reference signal) comprising a first set of first OFDM symbols that are consecutive and include a first center symbol and at least one pair of first side symbols disposed symmetrically about the first center symbol and having identical resource element sounding patterns;
means for combining the first side symbols in each of the at least one pair of first side symbols to produce at least one first combined symbol; and
means for determining a measurement of the OFDM PRS based on the at least one first combined symbol and the first center symbol.

Clause 20. The user equipment of clause 19, further comprising means for transmitting, to the network entity, a request for the OFDM PRS to consist of a symmetric transmission pattern.

Clause 21. The user equipment of clause 20, wherein the request comprises an indication of a threshold value of a comb number of the OFDM PRS.

Clause 22. The user equipment of clause 20, wherein the request comprises an indication of a type of the user equipment.

Clause 23. The user equipment of clause 19, further comprising means for transmitting, to the network entity, a request for the OFDM PRS to comprise a comb-2, 2-symbol resource with at least one consecutive repetition.

Clause 24. The user equipment of clause 23, wherein the request comprises an indication of a threshold quantity of the at least one consecutive repetition.

Clause 25. The user equipment of clause 23, wherein the request comprises an indication of a type of the user equipment.

Clause 26. The user equipment of clause 19, wherein the OFDM PRS comprises a comb-2, 2-symbol resource with at least one consecutive repetition such that the OFDM PRS comprises the first set of first OFDM symbols and at least one second set of second OFDM symbols that are consecutive with the first set of first OFDM symbols, with at least one of the first OFDM symbols being different from the second OFDM symbols and the second OFDM symbols of each of the at least one second set of second OFDM symbols including a second center symbol and at least one pair of second side symbols disposed symmetrically in time about the second center symbol and having identical resource element sounding patterns, wherein the measurement of the OFDM PRS is a first measurement of the OFDM PRS, and wherein the user equipment further comprises:
means for combining, for each of the at least one second set of second OFDM symbols, the second side symbols in each of the at least one pair of second side symbols to produce at least one second combined symbol; and
means for determining, for each of the at least one second set of second OFDM symbols, at least one second measurement of the OFDM PRS based on the at least one second combined symbol and the second center symbol of each of the at least one second set of second OFDM symbols.

Clause 27. The user equipment of clause 26, further comprising means for combining the first measurement of the OFDM PRS and the at least one second measurement of the OFDM PRS to determine a composite measurement of the OFDM PRS.

Clause 28. A non-transitory, processor-readable storage medium comprising processor-readable instructions to cause a processor of a user equipment to:
receive, from a network entity, an OFDM PRS (orthogonal frequency division multiplexing positioning reference signal) comprising a first set of first OFDM symbols that are consecutive and include a first center symbol and at least one pair of first side symbols disposed symmetrically about the first center symbol and having identical resource element sounding patterns;
combine the first side symbols in each of the at least one pair of first side symbols to produce at least one first combined symbol; and
determine a measurement of the OFDM PRS based on the at least one first combined symbol and the first center symbol.

Clause 29. The non-transitory, processor-readable storage medium of clause 28, further comprising processor-readable instructions to cause the processor to transmit, to the network entity, a request for the OFDM PRS to consist of a symmetric transmission pattern.

Clause 30. The non-transitory, processor-readable storage medium of clause 29, wherein the request comprises an indication of a threshold value of a comb number of the OFDM PRS.

Clause 31. The non-transitory, processor-readable storage medium of clause 29, wherein the request comprises an indication of a type of the user equipment.

Clause 32. The non-transitory, processor-readable storage medium of clause 28, further comprising processor-readable instructions to cause the processor to transmit, to the network entity, a request for the OFDM PRS to comprise a comb-2, 2-symbol resource with at least one consecutive repetition.

Clause 33. The non-transitory, processor-readable storage medium of clause 32, wherein the request comprises an indication of a threshold quantity of the at least one consecutive repetition.

Clause 34. The non-transitory, processor-readable storage medium of clause 32, wherein the request comprises an indication of a type of the user equipment.

Clause 35. The non-transitory, processor-readable storage medium of clause 28, wherein the OFDM PRS comprises a comb-2, 2-symbol resource with at least one consecutive repetition such that the OFDM PRS comprises the first set of first OFDM symbols and at least one second set of second OFDM symbols that are consecutive with the first set of first OFDM symbols, with at least one of the first OFDM symbols being different from the second OFDM symbols and the second OFDM symbols of each of the at least one second set of second OFDM symbols including a second center symbol and at least one pair of second side symbols disposed symmetrically in time about the second center symbol and having identical resource element sounding patterns, wherein the measurement of the OFDM PRS is a first measurement of the OFDM PRS, and wherein the non-transitory, processor-readable storage medium further comprises:
processor-readable instructions to cause the processor to combine, for each of the at least one second set of second OFDM symbols, the second side symbols in each of the at least one pair of second side symbols to produce at least one second combined symbol; and processor-readable instructions to cause the processor to determine, for each of
the at least one second set of second OFDM symbols, at least one second measurement of the OFDM PRS based on the at least one second combined symbol and the second center symbol of each of the at least one second set of second OFDM symbols.

Clause 36. The non-transitory, processor-readable storage medium of clause 35, further comprising processor-readable instructions to cause the processor to combine the first measurement of the OFDM PRS and the at least one second measurement of the OFDM PRS to determine a composite measurement of the OFDM PRS.

Clause 37. A network entity comprising:
a transceiver;
a memory; and
a processor communicatively coupled to the memory and the transceiver;
wherein the processor is configured to:
   schedule transmission of a first PRS (Positioning Reference Signal), of comb-2 with at least one repetition, in response to an inability indication that indicates an inability of a first user equipment to determine position information with at least a threshold accuracy based on measurement of comb-4, or higher-comb, PRS or based on any comb-2 PRS without a repetition; or
   schedule transmission of a second PRS that has sounded tones that are symmetrical about a middle symbol of the second PRS; or
   a combination thereof.

Clause 38. The network entity of clause 37, wherein the processor is configured to schedule transmission of the second PRS based on receiving a request via the transceiver from a second user equipment for the second PRS.

Clause 39. The network entity of clause 38, wherein the processor is configured to schedule transmission of the second PRS such that the second PRS consists, within a slot, of 2N−1 consecutive symbols where N is a comb number indicated in the request.

Clause 40. The network entity of clause 38, wherein the request comprises: one or more explicit indications of one or more parameters of the second PRS; or an implicit indication of the one or more parameters of the second PRS.

Clause 41. The network entity of clause 37, wherein the processor is configured to schedule transmission of the first PRS, wherein the inability indication indicates a type of the first user equipment to indicate, implicitly, the inability of the first user equipment to determine position information with at least the threshold accuracy based on PRS of comb-4 or higher, or based on comb-2 PRS without a repetition, and wherein the processor is configured to determine a quantity of repetitions of the at least one repetition based on the type of the first user equipment.

Clause 42. The network entity of clause 37, wherein the processor is configured to schedule transmission of the first PRS with a quantity of the at least one repetition corresponding to an explicit quantity indication in the inability indication.

Clause 43. A positioning reference signal scheduling method comprising:
scheduling, at a network entity, transmission of a first PRS (Positioning Reference Signal), of comb-2 with at least one repetition, in response to an inability indication that indicates an inability of a first user equipment to determine position information with at least a threshold accuracy based on measurement of comb-4, or higher-comb, PRS or based on any comb-2 PRS without a repetition; or
scheduling, at the network entity, transmission of a second PRS that has sounded tones that are symmetrical about a middle symbol of the second PRS; or
a combination thereof.

Clause 44. The positioning reference signal scheduling method of clause 43, comprising scheduling transmission of the second PRS based on receiving a request, at the network entity, from a second user equipment for the second PRS.

Clause 45. The positioning reference signal scheduling method of clause 44, wherein scheduling transmission of the second PRS comprises scheduling transmission of the second PRS such that the second PRS consists, within a slot, of 2N−1 consecutive symbols where N is a comb number indicated in the request.

Clause 46. The positioning reference signal scheduling method of clause 44, wherein the request comprises: one or more explicit indications of one or more parameters of the second PRS; or an implicit indication of the one or more parameters of the second PRS.

Clause 47. The positioning reference signal scheduling method of clause 43, comprising scheduling transmission of the first PRS, wherein the inability indication indicates a type of the first user equipment to indicate, implicitly, the inability of the first user equipment to determine position information with at least the threshold accuracy based on PRS of comb-4 or higher, or based on comb-2 PRS without a repetition, and wherein the positioning reference signal scheduling method further comprises determining, at the network entity, a quantity of repetitions of the at least one repetition based on the type of the first user equipment.

Clause 48. The positioning reference signal scheduling method of clause 43, comprising scheduling transmission of the first PRS with a quantity of the at least one repetition corresponding to an explicit quantity indication in the inability indication. Clause 49. A network entity comprising:
a transceiver; and
means for scheduling, via the transceiver, transmission of a first PRS (Positioning Reference Signal), of comb-2 with at least one repetition, in response to an inability indication that indicates an inability of a first user equipment to determine position information with at least a threshold accuracy based on measurement of comb-4, or higher-comb, PRS or based on any comb-2 PRS without a repetition; or
means for scheduling, via the transceiver, transmission of a second PRS that has sounded tones that are symmetrical about a middle symbol of the second PRS; or
a combination thereof.

Clause 50. The network entity of clause 49, comprising the means for scheduling transmission of the second PRS, wherein the means for scheduling transmission of the second PRS comprise means for scheduling transmission of the second PRS based on receiving a request via the transceiver from a second user equipment for the second PRS.

Clause 51. The network entity of clause 50, wherein the means for scheduling transmission of the second PRS comprise means for scheduling transmission of the second PRS such that the second PRS consists, within a slot, of 2N−1 consecutive symbols where N is a comb number indicated in the request.

Clause 52. The network entity of clause 50, wherein the request comprises: one or more explicit indications of one or more parameters of the second PRS; or an implicit indication of the one or more parameters of the second PRS.

Clause 53. The network entity of clause 49, comprising the means for scheduling transmission of the first PRS, wherein the inability indication indicates a type of the first user equipment to indicate, implicitly, the inability of the first user equipment to determine position information with at least the threshold accuracy based on PRS of comb-4 or higher, or based on comb-2 PRS without a repetition, and wherein the network entity further comprises means for determining a quantity of repetitions of the at least one repetition based on the type of the first user equipment.

Clause 54. The network entity of clause 49, comprising the means for scheduling transmission of the first PRS, wherein the means for scheduling transmission of the first PRS comprise means for scheduling transmission of the first PRS with a quantity of the at least one repetition corresponding to an explicit quantity indication in the inability indication.

Clause 55. A non-transitory, processor-readable storage medium comprising processor-readable instructions to cause a processor of a network entity to:
schedule transmission of a first PRS (Positioning Reference Signal), of comb-2 with at least one repetition, in response to an inability indication that indicates an inability of a first user equipment to determine position information with at least a threshold accuracy based on measurement of comb-4, or higher-comb, PRS or based on any comb-2 PRS without a repetition; or
schedule transmission of a second PRS that has sounded tones that are symmetrical about a middle symbol of the second PRS; or
a combination thereof.

Clause 56. The non-transitory, processor-readable storage medium of clause 55, comprising the processor-readable instructions to cause the processor to schedule transmission of the second PRS, wherein the processor-readable instructions to cause the processor to schedule transmission of the second PRS comprise processor-readable instructions to cause the processor to schedule transmission of the second PRS based on receiving a request from a second user equipment for the second PRS.

Clause 57. The non-transitory, processor-readable storage medium of clause 56, wherein the processor-readable instructions to cause the processor to schedule transmission of the second PRS comprise processor-readable instructions to cause the processor to schedule transmission of the second PRS such that the second PRS consists, within a slot, of 2N−1 consecutive symbols where N is a comb number indicated in the request.

Clause 58. The non-transitory, processor-readable storage medium of clause 56, wherein the request comprises: one or more explicit indications of one or more parameters of the second PRS; or an implicit indication of the one or more parameters of the second PRS.

Clause 59. The non-transitory, processor-readable storage medium of clause 55, comprising the processor-readable instructions to cause the processor to schedule transmission of the first PRS, wherein the inability indication indicates a type of the first user equipment to indicate, implicitly, the inability of the first user equipment to determine position information with at least the threshold accuracy based on PRS of comb-4 or higher, or based on comb-2 PRS without a repetition, and wherein the non-transitory, processor-readable storage medium further comprises processor-readable instructions to cause the processor to determine a quantity of repetitions of the at least one repetition based on the type of the first user equipment.

Clause 60. The non-transitory, processor-readable storage medium of clause 55, comprising the processor-readable instructions to cause the processor to schedule transmission of the first PRS, wherein the processor-readable instructions to cause the processor to schedule transmission of the first PRS comprise processor-readable instructions to cause the processor to schedule transmission of the first PRS with a quantity of the at least one repetition corresponding to an explicit quantity indication in the inability indication.

### Other Considerations

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations.

As used herein, the singular forms “a,” “an,” and “the” include the plural forms as well, unless the context clearly indicates otherwise. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items (possibly prefaced by “at least one of' or prefaced by “one or more of”) indicates a disjunctive list such that, for example, a list of “at least one of A, B, or C,” or a list of “one or more of A, B, or C” or a list of “A or B or C” means A, or B, or C, or AB (A and B), or AC (A and C), or BC (B and C), or ABC (i.e., A and B and C), or combinations with more than one feature (e.g., AA, AAB, ABBC, etc.). Thus, a recitation that an item, e.g., a processor, is configured to perform a function regarding at least one of A or B, or a recitation that an item is configured to perform a function A or a function B, means that the item may be configured to perform the function regarding A, or may be configured to perform the function regarding B, or may be configured to perform the function regarding A and B. For example, a phrase of “a processor configured to measure at least one of A or B” or “a processor configured to measure A or measure B” means that the processor may be configured to measure A (and may or may not be configured to measure B), or may be configured to measure B (and may or may not be configured to measure A), or may be configured to measure A and measure B (and may be configured to select which, or both, of A and B to measure). Similarly, a recitation of a means for measuring at least one of A or B includes means for measuring A (which may or may not be able to measure B), or means for measuring B (and may or may not be configured to measure A), or means for measuring A and B (which may be able to select which, or both, of A and B to measure). As another example, a recitation that an item, e.g., a processor, is configured to at least one of perform function X or perform function Y means that the item may be configured to perform the function X, or may be configured to perform the function Y, or may be configured to perform the function X and to perform the function Y. For example, a phrase of “a processor configured to at least one of measure X or measure Y” means that the processor may be configured to measure X (and may or may not be configured to measure Y), or may be configured to measure Y (and may or may not be configured to measure X), or may be configured to measure X and to measure Y (and may be configured to select which, or both, of X and Y to measure).

As used herein, unless otherwise stated, a statement that a function or operation is “based on” an item or condition means that the function or operation is based on the stated item or condition and may be based on one or more items and/or conditions in addition to the stated item or condition.

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed. Components, functional or otherwise, shown in the figures and/or discussed herein as being connected or communicating with each other are communicatively coupled unless otherwise noted. That is, they may be directly or indirectly connected to enable communication between them.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly, but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations, and does not limit the scope, applicability, or configurations of the claims. Rather, the preceding description of the configurations provides a description for implementing described techniques. Various changes may be made in the function and arrangement of elements.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

Having described several example configurations, various modifications, alternative constructions, and equivalents may be used. For example, the above elements may be components of a larger system, wherein other rules may take precedence over or otherwise modify the application of the disclosure. Also, a number of operations may be undertaken before, during, or after the above elements are considered. Accordingly, the above description does not bound the scope of the claims.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

1. A user equipment comprising:
a transceiver;
a memory; and
a processor, communicatively coupled to the memory and the transceiver, configured to:
receive, via the transceiver from a network entity, an OFDM PRS (orthogonal frequency division multiplexing positioning reference signal) comprising a first set of first OFDM symbols that are consecutive and include a first center symbol and at least one pair of first side symbols disposed symmetrically about the first center symbol and having identical resource element sounding patterns;
combine the first side symbols in each of the at least one pair of first side symbols to produce at least one first combined symbol; and
determine a measurement of the OFDM PRS based on the at least one first combined symbol and the first center symbol.

2. The user equipment of claim 1, wherein the processor is configured to transmit, via the transceiver to the network entity, a request for the OFDM PRS to consist of a symmetric transmission pattern.

3. The user equipment of claim 2, wherein the request comprises an indication of a threshold value of a comb number of the OFDM PRS.

4. The user equipment of claim 2, wherein the request comprises an indication of a type of the user equipment.

5. The user equipment of claim 1, wherein the processor is configured to transmit, via the transceiver to the network entity, a request for the OFDM PRS to comprise a comb-2, 2-symbol resource with at least one consecutive repetition.

6. The user equipment of claim 5, wherein the request comprises an indication of a threshold quantity of the at least one consecutive repetition.

7. The user equipment of claim 5, wherein the request comprises an indication of a type of the user equipment.

8. The user equipment of claim 1, wherein the OFDM PRS comprises a comb-2, 2-symbol resource with at least one consecutive repetition such that the OFDM PRS comprises the first set of first OFDM symbols and at least one second set of second OFDM symbols that are consecutive with the first set of first OFDM symbols, with at least one of the first OFDM symbols being different from the second OFDM symbols and the second OFDM symbols of each of the at least one second set of second OFDM symbols including a second center symbol and at least one pair of second side symbols disposed symmetrically in time about the second center symbol and having identical resource element sounding patterns, wherein the measurement of the OFDM PRS is a first measurement of the OFDM PRS, and wherein the processor is configured to, for each of the at least one second set of second OFDM symbols:
combine the second side symbols in each of the at least one pair of second side symbols to produce at least one second combined symbol; and
determine at least one second measurement of the OFDM PRS based on the at least one second combined symbol and the second center symbol of each of the at least one second set of second OFDM symbols.

9. The user equipment of claim 8, wherein the processor is configured to combine the first measurement of the OFDM PRS and the at least one second measurement of the OFDM PRS to determine a composite measurement of the OFDM PRS.

10. A positioning reference signal measurement method comprising:
receiving, at a user equipment from a network entity, an OFDM PRS (orthogonal frequency division multiplexing positioning reference signal) comprising a first set of first OFDM symbols that are consecutive and include a first center symbol and at least one pair of first side symbols disposed symmetrically about the first center symbol and having identical resource element sounding patterns;
combining the first side symbols in each of the at least one pair of first side symbols to produce at least one first combined symbol; and
determining a measurement of the OFDM PRS based on the at least one first combined symbol and the first center symbol.

11. The positioning reference signal measurement method of claim 10, further comprising transmitting, from the user equipment to the network entity, a request for the OFDM PRS to consist of a symmetric transmission pattern.

12. The positioning reference signal measurement method of claim 11, wherein the request comprises an indication of a threshold value of a comb number of the OFDM PRS.

13. The positioning reference signal measurement method of claim 11, wherein the request comprises an indication of a type of the user equipment.

14. The positioning reference signal measurement method of claim 10, further comprising transmitting, from the user equipment to the network entity, a request for the OFDM PRS to comprise a comb-2, 2-symbol resource with at least one consecutive repetition.

15. The positioning reference signal measurement method of claim 14, wherein the request comprises an indication of a threshold quantity of the at least one consecutive repetition.

16. The positioning reference signal measurement method of claim 14, wherein the request comprises an indication of a type of the user equipment.

17. The positioning reference signal measurement method of claim 10, wherein the OFDM PRS comprises a comb-2, 2-symbol resource with at least one consecutive repetition such that the OFDM PRS comprises the first set of first OFDM symbols and at least one second set of second OFDM symbols that are consecutive with the first set of first OFDM symbols, with at least one of the first OFDM symbols being different from the second OFDM symbols and the second OFDM symbols of each of the at least one second set of second OFDM symbols including a second center symbol and at least one pair of second side symbols disposed symmetrically in time about the second center symbol and having identical resource element sounding patterns, wherein the measurement of the OFDM PRS is a first measurement of the OFDM PRS, and wherein the positioning reference signal measurement method further comprises, for each of the at least one second set of second OFDM symbols:
combining the second side symbols in each of the at least one pair of second side symbols to produce at least one second combined symbol; and
determining at least one second measurement of the OFDM PRS based on the at least one second combined symbol and the second center symbol of each of the at least one second set of second OFDM symbols.

18. The positioning reference signal measurement method of claim 17, further comprising combining the first measurement of the OFDM PRS and the at least one second measurement of the OFDM PRS to determine a composite measurement of the OFDM PRS.

19. A network entity comprising:
a transceiver;
a memory; and
a processor communicatively coupled to the memory and the transceiver;
wherein the processor is configured to:
schedule transmission of a first PRS (Positioning Reference Signal), of comb-2 with at least one repetition, in response to an inability indication that indicates an inability of a first user equipment to determine position information with at least a threshold accuracy based on measurement of comb-4, or higher-comb, PRS or based on any comb-2 PRS without a repetition; or
schedule transmission of a second PRS that has sounded tones that are symmetrical about a middle symbol of the second PRS; or
a combination thereof.

20. The network entity of claim 19, wherein the processor is configured to schedule transmission of the second PRS based on receiving a request via the transceiver from a second user equipment for the second PRS.

21. The network entity of claim 20, wherein the processor is configured to schedule transmission of the second PRS such that the second PRS consists, within a slot, of 2N−1 consecutive symbols where N is a comb number indicated in the request.

22. The network entity of claim 20, wherein the request comprises: one or more explicit indications of one or more parameters of the second PRS; or an implicit indication of the one or more parameters of the second PRS.

23. The network entity of claim 19, wherein the processor is configured to schedule transmission of the first PRS, wherein the inability indication indicates a type of the first user equipment to indicate, implicitly, the inability of the first user equipment to determine position information with at least the threshold accuracy based on PRS of comb-4 or higher, or based on comb-2 PRS without a repetition, and wherein the processor is configured to determine a quantity of repetitions of the at least one repetition based on the type of the first user equipment.

24. The network entity of claim 19, wherein the processor is configured to schedule transmission of the first PRS with a quantity of the at least one repetition corresponding to an explicit quantity indication in the inability indication.

25. A positioning reference signal scheduling method comprising:
scheduling, at a network entity, transmission of a first PRS (Positioning Reference Signal), of comb-2 with at least one repetition, in response to an inability indication that indicates an inability of a first user equipment to determine position information with at least a threshold accuracy based on measurement of comb-4, or higher-comb, PRS or based on any comb-2 PRS without a repetition; or
scheduling, at the network entity, transmission of a second PRS that has sounded tones that are symmetrical about a middle symbol of the second PRS; or
a combination thereof.

26. The positioning reference signal scheduling method of claim 25, comprising scheduling transmission of the second PRS based on receiving a request, at the network entity, from a second user equipment for the second PRS.

27. The positioning reference signal scheduling method of claim 26, wherein scheduling transmission of the second PRS comprises scheduling transmission of the second PRS such that the second PRS consists, within a slot, of 2N−1 consecutive symbols where N is a comb number indicated in the request.

28. The positioning reference signal scheduling method of claim 26, wherein the request comprises: one or more explicit indications of one or more parameters of the second PRS; or an implicit indication of the one or more parameters of the second PRS.

29. The positioning reference signal scheduling method of claim 25, comprising scheduling transmission of the first PRS, wherein the inability indication indicates a type of the first user equipment to indicate, implicitly, the inability of the first user equipment to determine position information with at least the threshold accuracy based on PRS of comb-4 or higher, or based on comb-2 PRS without a repetition, and wherein the positioning reference signal scheduling method further comprises determining, at the network entity, a quantity of repetitions of the at least one repetition based on the type of the first user equipment.

30. The positioning reference signal scheduling method of claim 25, comprising scheduling transmission of the first PRS with a quantity of the at least one repetition corresponding to an explicit quantity indication in the inability indication.
